(19) United States
(12) Patent Application Publication
(10) Pub. No.: US 2018/0015498 A1
(43) Pub. Date: Jan. 18, 2018

(54) APPARATUS AND METHOD OF SCREEN DECORATING METALLIC CONTAINERS

(71) Applicant: BALL CORPORATION, Broomfield, CO (US)

(72) Inventors: Paul Nicol, Melksham (GB); Jason Galley, Lockeridge (GB)

(73) Assignee: BALL CORPORATION, Broomfield, CO (US)

(21) Appl. No.: 15/647,929

(22) Filed: Jul. 12, 2017

Related U.S. Application Data
(60) Provisional application No. 62/361,630, filed on Jul. 13, 2016.

(51) Int. Cl. B05C 11/02; B05D 5/06; B05D 3/12; B05D 1/40; B44D 2/00; B05B 13/00

(52) U.S. Cl. CPC B05C 11/023; B05D 3/12; B05D 1/40; B05D 5/061; B05B 13/00; B44D 2/00

(57) ABSTRACT

An apparatus and methods of decorating a metallic container are provided. More specifically, the present invention relates to apparatus and methods used to provide a decoration on a predetermined surface of a metallic container body. The decoration may be registered with decorations previously applied to the container body. In one embodiment, the apparatus includes a screen print unit with a cylindrical body. The cylindrical body rotationally applies a predetermined type or color of ink or other coating, such as a varnish, to the cylindrical body. In one embodiment, the apparatus applies a varnish to a selected portion of the cylindrical body without applying the varnish to all of the cylindrical body. Additionally, the apparatus may also include a foiling unit that applies a label to the cylindrical body.

### CROSS-REFERENCE TO RELATED APPLICATIONS

This application claims priority under 35 U.S.C. §119(e) to U.S. Provisional Patent Application Ser. No. 62/361,630, filed Jul. 13, 2016, entitled “Apparatus and Method of Decorating Metallic Containers,” and which is incorporated herein in its entirety by reference.

### FIELD OF THE INVENTION

The present invention relates generally to the manufacture of containers. More specifically, this invention provides an apparatus and methods used to decorate metallic containers. In one embodiment, a screen print unit can apply a decorating material to a predetermined portion of an exterior surface of a metallic container. The decorating material may be registered with a decoration previously applied to the container exterior surface. The decorating material may be one of an ink, a varnish, and an adhesive.

### BACKGROUND

Metallic containers offer distributors and consumers many benefits. The metallic body of a metallic container provides optimal protection properties for products. For example, the metallic body prevents CO₂ migration and transmission of UV radiation which may damage the contents of the metallic container, negatively influencing the effectiveness of ingredients, as well as the flavor, appearance, or color of the product. Metallic containers also offer an impermeable barrier to light, water vapor, oils and fats, oxygen, and micro-organisms and keep the contents of the metallic container fresh and protected from external influences, thereby guaranteeing a long shelf-life.

Additionally, many consumers prefer metallic containers compared to containers made of glass or plastic. Metallic containers are particularly attractive to consumers because of the convenience they offer. The light weight of metallic containers makes them easier to carry than glass containers.

The exterior surfaces of metallic containers are also ideal for decorating with brand names, logos, designs, product information, and/or other preferred indicia for identifying, marketing, and distinguishing the metallic container and its contents from other products and competitors. Thus, metallic containers offer bottlers, distributors, and retailers an ability to stand out at the point of sale.

As a result of these and other benefits, sales of metallic containers were valued at approximately $53 billion globally in 2014. A large percentage of the metallic container market is driven by beverage containers. According to one report, approximately 290 billion metallic beverage containers were shipped globally in 2012. One U.S. trade group reported that 126 billion metallic containers were shipped in the U.S. alone in 2014. To meet this demand, metallic container manufacturing facilities operate some of the fastest, if not the fastest, production lines in the container industry. Because of the high speeds of the production lines, techniques or processes that may work in other industries or with containers formed of other materials do not necessarily work at the high speeds required for metallic container production lines. Accordingly, specialized equipment and techniques are often required for many of the operations used to form and decorate metallic containers.

Metallic containers are frequently decorated with an image or indicia, such as a brand name, logo, product information, or design, by a first printer or decorator. The first decorator may use a lithographic or off-set printing process. In lithographic printing, one or more printing plates with image regions are attached to a plate cylinder (or press cylinder) of a decorator. The image regions can include both ink receiving regions and areas that do not receive ink. An inker applies ink to the printing plates and the ink adheres to the ink receiving regions. Usually the printing plates of the plate cylinder receive only one particular color of ink from the inker. Accordingly, to produce a lithographic image with more than one ink, lithographic decorators frequently have two or more plate cylinders with printing plates. Each plate cylinder includes an inker that applies a single color or type of ink to the printing plates of the plate cylinder with which the inker is associated.

The decorator also has a blanket cylinder (also known as an offset cylinder, a printing cylinder, or a segment wheel). Printing blankets (or transfer plates or blankets) are attached to the blanket cylinder. Decorators used in the metallic container industry typically have from 2 to 12 transfer blankets on the blanket cylinder. As the plate cylinders and blanket cylinder rotate in unison with respect to one another, a printing plate on each of the plate cylinders contacts a transfer blanket and transfers a particular color of ink to the transfer blanket. When all of the printing plates have transferred their ink colors and images to the transfer blanket, the final lithographic image is formed on the transfer blanket. A metallic container is then brought into rotational contact with the transfer blanket of the blanket cylinder and the lithographic image is transferred from the transfer blanket to the exterior surface of the metallic container.

As will be appreciated by one skilled in the art, off-set printing includes dry off-set printing and wet off-set printing. In dry off-set printing, the printing plates are not dampened with water. The images formed on the printing plates have a mechanical relief that defines where the printing plates receive ink from inkers. The printing plates then transfer their inked images to the transfer blankets which subsequently transfer the ink to the exterior surface of a metallic container. In contrast, in wet off-set lithographic processes, the printing plates are chemically treated to form image areas that will accept ink but repel water. Water and ink are then applied to the printing plates. Because of the chemical treatment of the printing plates, only the ink adheres to the images and the water is repelled. Additionally, the ink does not adhere to the non-image areas of the printing plates.

Various examples of printing methods and apparatus are described in U.S. Pat. No. 3,960,073; U.S. Pat. No. 4,384,518; U.S. Pat. No. 5,970,865, U.S. Pat. 6,041,705; U.S. Pat. No. 6,223,653; U.S. Pat. No. 6,490,969; U.S. Pat. No. 6,550,389; U.S. Pat. No. 6,769,357; U.S. Pat. No. 6,899,998; U.S. Pat. No. 8,596,624; U.S. Pat. No. 8,708,271; U.S. Pat. No. 9,032,872; U.S. Pat. No. 9,327,493; U.S. Pat. No. 9,409,433; U.S. Pat. No. 9,555,616; U.S. Patent App. Pub. No. 2006/0137548; U.S. Patent App. Pub. No. 2007/0071897, U.S. Patent App. Pub. No. 2011/0067584; U.S. Patent App. Pub. No. 2015/0174917; U.S. Patent App. Pub. No. 2013/0176358; U.S. Patent App. Pub. No. 2013/0269551; U.S. Patent App. Pub. No. 2015/0183211; U.S. Patent App. Pub. No. 2016/0129687; U.S. Patent App. Pub. No. 2017/0087872, WIPO Publication No. WO2008/092940; WIPO Publication No. WO 2014/006517; WIPO Publication No. WO 2014/008544; WIPO Publication No. WO 2014/128200; WIPO Publication No. WO 2014/201005; and WIPO Publication No. 2016/168488, which are each incorporated herein by reference in their entireties.

A subsequent decorator may apply additional decorations, including an over-varnish, to the decorated metallic container. Some prior art decorators use off-set printing methods to apply additional decorations to the exterior surface of metallic containers. However, prior art off-set decorators do not provide a sufficient weight or thickness of ink to achieve some desired decorations. Other prior art decorators cannot transfer some specialty inks or pigmented inks. Further, some prior art decorators which include rollers cannot register decorations with previously applied decorations. More specifically, prior art decorators which include a roller to form a decoration do not include mandrels which can be rotated to register a metallic container with the roller.

In some cases, a silk screen method (also known as a “screen printing” method) may be used to apply inks to the decorated metallic container. Some silk screen apparatus for decorating metallic containers are known, such as those described in U.S. Pat. No. 4,434,714; U.S. Pat. No. 6,223,653; U.S. Pat. No. 6,283,022; U.S. Pat. No. 6,412,407; U.S. Pat. No. 6,684,770; U.S. Pat. No. 9,333,740; U.S. Pat. App. Pub. 2007/0039490; and U.S. Pat. App. Pub. 2013/0068385 which are each incorporated herein by reference in their entireties.

Silk screen apparatuses typically use flat screens to apply ink to the exterior surfaces of the metallic containers. The flat screens of these apparatus result in relatively slow production rates that are not suitable for high-speed decorators required in the commercial container industry. In some metallic container production lines, such as those related to metallic containers formed by an impact extrusion process, decorators may operate at from about 120 to about 240 metallic containers per minute. In beverage container manufacturing lines, production equipment, including decorators, typically must operate at 500-700 metallic containers per minute. More preferably, decorators may be required to operate at production speeds of at least one thousand, and even more preferably, several thousand cylindrical metallic containers per minute.

Known screen printing assemblies within prior art silk screen apparatus also frequently occupy a substantial amount of space. For example, the stroke length of the screen printing assemblies may be up to about 36 inches. As a result, the space provided for curing the screen-printed ink is often inadequate. Thus, prior art silk screen apparatus are generally undesirable for multi-colored screen printing operations where curing is required between each screen printing workstation. The limited space of the prior art silk screen apparatus is more significant when screen printing multiple registered layers of a printing ink. The multiple layers of ink require overprinting of one layer of ink with the next layer of ink without the adverse consequences of streaking of the previously applied layer.

Some prior art silk screen apparatus include mandrels that are arranged radially around a rotatable mandrel wheel. The mandrels thus have axes that are generally transverse or perpendicular to an axis of rotation of the mandrel wheel. This arrangement of the mandrels detrimentally increases the size of the silk screen apparatus such that the silk screen apparatus takes up a substantial, and unacceptable, amount of space in the production facility. One example of a prior art silk screen apparatus that includes mandrels arranged in this manner is U.S. Pat. No. 7,997,193 which is incorporated herein by reference in its entirety.

Further, prior art silk screen apparatuses do not register the additional decorations with previous decorations of the metallic containers. For example, prior art silk screen printing apparatuses cannot register a decoration with a previous decoration applied by an upstream printer. Thus, prior art silk screen apparatuses cannot typically be used with previously decorated metallic containers.

To complete some decorations, an over-varnish is applied to the exterior surface of the metallic containers. One method of applying the over-varnish includes the use of cylindrical rollers. However, these rollers cannot be registered with previously applied decorations. More specifically, in some prior art varnishers, the roller continuously receives varnish as the roller rotates. Containers rotate in contact with the roller such that the entire exterior surface of the containers is coated with at least some varnish. Accordingly, the prior art varnisher cannot selectively apply varnish to only selected portions of the container exterior surface. Thus, the prior art varnisher may not be used to form a metallic container with a combination of varnished and unvarnished decorations. Further, prior art varnishers cannot apply two different varnishes to different portions of the metallic container. Other prior art varnishers cannot leave one cylindrical exterior portion of a metallic container unvarnished while varnishing a second cylindrical exterior portion of the metallic container. One example of a prior art varnisher is described in U.S. Pat. No. 4,441,418 which is incorporated herein by reference in its entirety.

Another method of applying over-varnish uses flexographic printing. Prior art flexographic printing systems generally use an “Anilox” roller. The Anilox roller meters a predetermined amount of decorating material (such as an ink) onto a printing plate. The ink is subsequently transferred from the printing plate to a metallic container. However, the Anilox roller is not capable of applying sufficient amounts of specialty inks or varnishes to the printing plate to produce certain desired decorations on metallic containers. For example, some prior art Anilox rollers lay down approximately 3 to 4 micrometers of ink on the printing plate. The limited thickness of ink applied by the Anilox roller also prevents the use of some specialty inks that include pigments with a diameter of greater than 3 micrometers. As one of skill in the art will appreciate, pigments are the component of an ink that imparts gloss, color, texture, and other characteristics to a printed image.

Due to the limitations associated with prior art apparatus and methods of decorating metallic containers, there is an unmet need for a decorator that applies decorations to metallic containers without sacrificing production efficiency or image quality and detail and that is operable to register the decorations with previously formed decorations or other indicia on the exterior surface of a cylindrical container.

### SUMMARY OF THE INVENTION

The present invention provides apparatus and methods for decorating metallic containers in a cost-effective, fast, and reliable manner and which can form images of higher quality than known screen decorators. One aspect of the present invention is a decorator that uses a screen print unit to decorate an exterior body portion of a metallic container. In one embodiment, the screen print unit comprises a cylindrical body to rotationally transfer a decorating material to an exterior surface of the metallic container. In one embodiment, the screen print unit can transfer decorating material to one or more selected portions of the container exterior surface. In one embodiment, the decorating material may be one of an ink, a varnish, and an adhesive.

A mandrel of a conveyor moves the metallic container into alignment with the screen print unit. In one embodiment, the conveyor is a mandrel wheel. The mandrel wheel may include any number of mandrels each adapted to receive metallic containers. In one embodiment, the mandrel wheel includes twelve mandrels. Each mandrel is operable to rotate a metallic container into a predetermined alignment with the screen print unit. In one embodiment, a mandrel can rotate around a mandrel axis that is substantially parallel to an axis of the mandrel wheel. In one embodiment, the cylindrical body of the screen print unit rotates around an axis that is substantially parallel to the mandrel wheel axis and the axes of the mandrels.

In one embodiment, a control system of the decorator determines if a metallic container is in the predetermined alignment with the screen print unit. In another embodiment, if a metallic container is not in the predetermined alignment, the control system can determine an amount of movement of a mandrel required to move the metallic container into the predetermine alignment. The control system may then send a signal to the mandrel to move the metallic container into the predetermined alignment. In one embodiment, the mandrel rotates in a specific direction in response to the signal.

Another aspect of the present invention is a decorator operable to apply decorations in predetermined locations to a previously decorated metallic container. In this manner, the decorator can register the decorated metallic container in a predetermined position and apply additional decorations without interfering with previously applied decorations. Optionally, the decorator may apply decorations that add to, or at least partially cover, the previously applied decorations. The decorator may include a plurality of decorating units. The decorating units may be at least one of a screen print unit, a label unit, and a digital printing unit. The screen print unit can transfer a decorating material to a predetermined portion of the metallic container. In one embodiment, the decorating material is one of an ink, a varnish, and an adhesive.

In one embodiment, the decorator includes a plurality of mandrels operable to index metallic containers to the decorating units. In another embodiment, the mandrels can rotate in at least on direction to register the decorated metallic container in the predetermined position. In one embodiment, an actuator is associated with each mandrel.

A sensor of the decorator can identify an orientation of the previously applied decorations. In one embodiment, the sensor identifies a position of the previously applied decorations. Drive units interconnected to mandrels of the decorator then rotate the mandrels and the metallic containers positioned thereon such that the previously applied decorations are in a predetermined orientation with each decorating unit of the decorator. Optionally, the sensor may include an optical camera. In one embodiment, the decorator may include a plurality of sensors. For example, in one embodiment, a sensor is associated with each mandrel. In another embodiment, a sensor is associated with each decorating unit.

In one embodiment, decorating units may be added to, and removed from, the decorator. More specifically, in one embodiment, the order, type, and number of decorating units of the decorator may be changed to alter the order, type, and number of decorating materials applied to a metallic container. Said differently, each decorating unit may be used at any decorating location of the decorator. Further, the type of the decorating units may be changed. In one embodiment, the decorator includes each of a screen print unit and a label unit. Optionally, the decorator may also include a digital print unit. Additionally, in one embodiment, other decorating units (such as a screen print unit, a label unit, and a digital print unit) may be added to the decorator.

In one embodiment, the decorator includes at least three screen print units. A first screen print unit may apply a first varnish. A second screen print unit may apply a second varnish. A third screen print unit may apply an adhesive. Optionally, the first varnish, the second varnish, and the adhesive may be registered with respect to each other. In one embodiment, the first and second screen print units may be oriented to apply the first and second varnishes to a metallic container before the third screen print unit applies the adhesive to the metallic container. Optionally, in another embodiment, the third screen print unit is oriented to apply the adhesive to the metallic container before the first and second screen print units apply the first and second varnishes to the metallic container.

In one embodiment, the previously applied decorations include a registration mark. In another embodiment, the registration mark is printed by an upstream decorating system on a predetermined exterior surface of the metallic container. The sensor identifies the position of the registration mark to determine the orientation of the decoration with respect to the decorating unit. A drive unit interconnected to the mandrel then rotates the mandrel and the metallic container thereon such that the registration mark is in a predetermined orientation with respect to the decorating unit.

In one embodiment, metallic container may be registered with each of a plurality of decorating units of the decorator. Accordingly, in one embodiment, a mandrel with a metallic container may rotate in a specific direction such that the metallic container is in a specific orientation with respect to a first decorating unit. After the first decorating unit applies a first decorating material to a first portion of the metallic container, the mandrel moves the metallic container to a second decorating unit. The mandrel may rotate in a specific direction to orient the metallic container with respect to the second decorating unit. Once the second decorating unit applies a second decorating material to a second portion of the metallic container, the mandrel may move the metallic container to a third decorating unit. The mandrel may rotate in a specific direction such that the metallic container is in a predetermined orientation with respect to the third decorating unit.

The decorator may also include a control system. The control system receives information related to the position and/or orientation of the previously applied decorations on a metallic container from the sensor. The control system then determines if the previously applied decorations are in the predetermined orientation with respect to each decorating unit. If the previously applied decorations are not in the predetermined orientation, the control system sends a signal to a drive unit associated with a mandrel on which the metallic container is positioned. The signal directs the drive unit to rotate axially in a predetermined direction by a predetermined amount to move the previously applied decorations into the predetermined orientation. In one embodiment, the control system includes a processor. The processor is operable to execute non-transitory instructions stored in a memory. The instructions cause the processor of the control system to execute the methods described herein.

In another aspect, the decorator is operable to apply a variety of different decorations to the container body surface. For example, the decorator may apply one or more types of specialty inks, varnishes, adhesives, foils, labels, laser marks, and finishes (such as matte, semi-matte, and gloss finishes) to the container body surface. In one embodiment, each of the one or more specialty inks, varnishes, adhesives, laser marks, foils, labels, and finishes may be applied to different predetermined surfaces of the container body and/or registered with decorations previously applied to the metallic container.

One aspect of the present invention is a decorator which is operable to selectively apply a varnish to predetermined portions of a cylindrical exterior surface of a metallic container. The varnish may be registered with a decoration on the cylindrical exterior surface. The decoration may be formed by a decorating unit of the decorator. Alternatively, in another embodiment, the decoration may be formed by a decorator of upstream equipment. In one embodiment, the varnish may be applied to at least a portion of the decoration. In another embodiment, the varnish is not applied to the decoration. In one embodiment, at least a portion of the cylindrical exterior surface of the metallic container does not receive a varnish from the decorator.

In one embodiment, the decorator moves the metallic container into a predetermined orientation with respect to a decorating unit of the decorator. More specifically, in one embodiment, the decorator includes a mandrel which receives the metallic container. The decorator may rotate the mandrel in at least one direction to orient a predetermined portion of the cylindrical exterior surface of the metallic container with respect to the decorating unit. In one embodiment, an actuator is associated with the mandrel. The actuator may be a drive unit, such as a servo motor or other mechanical or electrical means operable to rotate the mandrel in one or more directions.

In one embodiment, the decorator includes a sensor that can detect a registration mark on the cylindrical exterior surface. In another embodiment, a control unit of the decorator may receive information from the sensor. The control unit can determine the orientation of the cylindrical exterior surface of the metallic container using the information from the sensor. If the cylindrical exterior surface is not in the predetermined orientation, the control system can send a signal to the actuator to rotate in a specific direction by a specific amount.

In one embodiment, the decorator applies a first varnish to a first portion of the cylindrical exterior surface. The decorator may optionally apply a second varnish to a second portion of the cylindrical exterior surface. In one embodiment, the first varnish is different from the second varnish. In one embodiment, the first varnish creates a gloss finish to the first portion. In another embodiment, the second varnish creates a matt or a semi-matt finish to the second portion. In another embodiment, the decorator does not apply a varnish to a third portion of the cylindrical exterior surface. Thus, in one embodiment, the decorator is operable to form a metallic container with a first portion with the first varnish, a second portion with the second varnish, and a third portion with no varnish.

In one embodiment, the decorator includes at least one screen print unit operable to apply a varnish to a predetermined portion of the cylindrical exterior surface. In another embodiment, the screen print unit includes a cylindrical screen that can apply varnish to the predetermined portion. The predetermined portion of the cylindrical exterior surface may have any size or shape. In one embodiment, the predetermined portion has a size and shape which correspond to at least a portion of the decoration on the cylindrical exterior surface. Accordingly, in one embodiment, the decorator may apply a varnish to at least a portion of the decoration. In another embodiment, the decorator can apply the varnish to all of the decoration. In one embodiment, the predetermined portion of the cylindrical exterior surface of the metallic container does not intersect the decoration. Thus, in one embodiment, the decorator does not apply the varnish to the decoration.

Still another aspect of the present invention is to provide a decorator with a cure element. The decorator may include any number of cure elements. Each cure element can be positioned in a predetermined orientation with respect to at least one decorating unit of the decorator. In one embodiment, the cure element comprises a light source that produces light of a predetermined wavelength to dry, or set, a decorating material applied to the surface of the container body. The decorating material may be one or more of an ink, a varnish, and an adhesive. In one embodiment, the cure elements emit ultraviolet (UV) light with a wavelength selected to cure the specialty inks or varnishes applied by the screen print units. In another embodiment, the cure elements comprise LED elements that emit the UV light. In another embodiment, the cure elements comprise conventional UV elements. Additionally, or alternatively, the light emitted by the cure element may be infrared. In another embodiment, the cure element produces one or more of heat, light, and electrons to cure the ink.

In one embodiment, a cure element is associated with each decorating unit. Optionally, two or more cure elements may be associated with a decorating unit. The decorating units may comprise screen print units. In one embodiment, the cure elements are positioned proximate to, and radially inward of, the screen print units. In one embodiment, the cure elements are positioned radially inward of a path of mandrels of a mandrel wheel. Optionally, the screen print units are positioned radially outward of the path of the mandrels. In another embodiment, the cure elements are aligned with a radius of the mandrel wheel that does not intersect the screen print units. In yet another embodiment, a shield may be positioned between a cure element and a screen print unit. In this manner, the screen print unit is not struck by energy emanating from the cure element. This prevents curing of inks or other decorating material on the screen print units.

In one embodiment, the decorator is operable to apply one or more decorating materials to an exterior surface of a metallic container. Optionally, the decorating materials may be applied to one or more separate portions of the exterior surface of the container. In another embodiment, the decorating materials include inks, varnishes, and adhesives. The inks may be of distinct types and colors, including a specialty ink. The specialty ink may comprise one or more of a thermochromic ink, a photochromic ink, a scented thermochromic ink, a fluorescent ink, a UV ink, a black light ink, an infrared ink, a phosphorescent ink, a pressure sensitive ink, a tactile ink, a thermo-tactile ink, a leuco dye, a matte ink, and a pigmented ink. In one embodiment, the decorator may apply two or more different varnishes to two different portions of the exterior surface. The varnishes may be registered with decorations previously applies to the exterior surface.

It is one aspect of the present invention to provide an apparatus for applying a decorating material to a predetermined portion of a cylindrical exterior surface of a metallic container. The apparatus may include, one or more of, but is not limited to: (1) a conveyor to transport the metallic container; (2) a feeder to receive the metallic container from the conveyor; (3) a mandrel wheel in a predetermined alignment with respect to the feeder; (4) a plurality of mandrels interconnected to the mandrel wheel, the mandrels adapted to receive metallic containers from the feeder; and (5) a decorating unit aligned in a predetermined position with respect to the mandrels of the mandrel wheel. In one embodiment, the decorating unit is configured to apply a predetermined decorating material on the selected portion of the container exterior surface. In one embodiment, each of the mandrels is operable to selectively rotate in at least one direction. In another embodiment, the mandrels each include a mandrel axis which is substantially parallel to an axis of the mandrel wheel.

In one embodiment, the decorating material may comprise one of: (A) a predetermined color of ink; (B) a predetermined type of ink; (C) a predetermined varnish; (D) a laser mark; (E) an adhesive; and (F) a label. The ink may be a pigmented ink or a specialty ink. In one embodiment, the pigmented ink includes pigments that have a diameter of between about 2 micrometers and about 8 micrometers. In one embodiment, the label includes an adhesive prior to being applied to the cylindrical exterior surface. In another embodiment, the label is applied to an adhesive on the cylindrical exterior surface. Optionally, the label may comprise one or more of a paper, a plastic, and a metal. In one embodiment, the label is a foil label.

In one embodiment, the decorating unit comprises a screen print unit. Optionally, the screen print unit includes a cylindrical body portion. The cylindrical body portion is configured to rotationally apply the predetermined decorating material to the cylindrical exterior surface. In one embodiment, the cylindrical body portion is operable to rotate around a screen axis. In another embodiment, the screen axis is substantially parallel to the axis of the mandrel wheel. In another embodiment, the mandrel rotates the metallic container into a predetermined orientation such that the decorating material applied by the screen print unit registers with a first decoration previously applied to the cylindrical exterior surface of the metallic container. In this manner, the decorating material can be selectively positioned in a predetermined location of the metallic container.

Optionally, in another embodiment, the apparatus further includes one or more of a second screen print unit and a third screen print unit. The second screen print unit includes a second cylindrical body portion to rotationally apply a second predetermined decorating material to a selected second portion of the container body. The third screen print unit includes a third cylindrical body portion to rotationally apply a third predetermined decorating material to a selected third portion of the container body. In one embodiment, one of the first, second, and third screen print units can apply an adhesive material to the cylindrical exterior surface of the metallic container.

In another embodiment, the apparatus includes a cure element to cure the decorating material. In one embodiment, the apparatus includes a cure element associated with each decorating unit that applies an ink or a varnish to the cylindrical exterior surface. Additionally, the cure element may optionally be interconnected to a hub of the mandrel wheel. In another embodiment, the cure element is aligned radially with the mandrel wheel. For example, the cure element may be positioned radially inward, or radially outward, of a path of the mandrels.

The decorating unit may also comprise at least one of a label unit and a digital print unit. The label unit may apply a label to a selected portion of the container cylindrical exterior surface. In one embodiment, the label is applied to an adhesive previously applied to the cylindrical exterior surface. The digital print unit may comprise a laser marking unit. In another embodiment, the digital printing unit includes an inkjet print head.

The apparatus may further comprise a sensor to identify a location of a first decoration previously applied to the cylindrical exterior surface of the metallic container. The sensor may comprise an optical camera. In one embodiment, a sensor is associated with each mandrel of the apparatus. In another embodiment, a sensor is associated with each decorating unit of the apparatus. In one embodiment, the sensor is operable to detect a registration mark (known as a “T” mark) on the container exterior surface.

A control system may also be included with the apparatus. The control system can receive data from the sensor. By analyzing the sensor data, the control system can determine if the first decoration is in a predetermined orientation with respect to one or more decorating units of the apparatus. If the first decoration is not in the predetermined orientation, the control system can send a signal to a drive unit associated with the mandrel. The drive unit can rotate the mandrel and the metallic container thereon such that the first decoration is in the predetermined orientation with respect to the decorating unit.

In one embodiment, a sensor collects or obtains data from the cylindrical exterior surface of the metallic container. In one embodiment, the metallic container includes a registration mark. The control system receives the data collected by the sensor. Using the sensor data, the control system can determine the position of the registration mark and the orientation of the cylindrical exterior surface with respect to one or more of the decorating units. Thus, specific decorations can be applied to specific, predetermined locations on the cylindrical exterior surface of the metallic container.

It is another aspect of the present invention to provide a method of decorating an exterior surface of a metallic container. The method includes one or more of, but is not limited to: (1) receiving, by a feeder of a decorator, a metallic container; (2) positioning the metallic container on a mandrel; (3) moving the mandrel such that the metallic container is in a predetermined alignment with respect to a decorating unit of the decorator; and (4) decorating a selected portion of an exterior surface of the metallic container body with at least one decorating material. The decorating material may comprise one or more of: (i) an ink; (ii) a varnish; (iii) a laser mark; (iv) an adhesive; and (v) a label. In one embodiment, the ink may be of a particular color or type. In one embodiment, the exterior surface of the metallic container is generally cylindrical.

In one embodiment, the mandrel extends from a mandrel wheel of the decorator. In another embodiment, the mandrel wheel rotates the mandrel proximate to the decorating unit. In one embodiment, the decorator includes from one to ten decorating units. Optionally, each decorating unit may apply a different decorating material to the exterior surface of the metallic container.

In one embodiment, the method includes adding a decorating unit to the decorator. Optionally, the method may include removing a decorating unit from the decorator. In another embodiment, the method includes moving a first decorating with respect to a second decorating unit. In this manner, the first decorating unit can be oriented to apply a first decorating material before, or after, the second decorating unit applies a second decorating material.

Optionally, the method may further comprise rotating the metallic container into a predetermined alignment with respect to a curing unit and curing the decorating material on the exterior surface of the metallic container. Additionally, the method may also comprise rotating the metallic container proximate to a second decorating unit of the decorator. In one embodiment, the mandrel rotates the metallic container into a predetermined alignment with the second decorating unit. The second decorating unit may then decorate a second selected portion of the container exterior surface.

In one embodiment, the method may also include sensing the exterior surface of the metallic container. In one embodiment, the container exterior surface is sensed to determine an orientation of a first decoration previously applied to the container exterior surface. Optionally, the first decoration may include a registration mark. A control system may then determine if the first decoration is in a predetermined orientation with respect to a decorating unit of the apparatus. When the first decoration is not in the predetermined orientation, the control system can send a signal to a motor (or other electronically controlled drive means) of the mandrel to rotate the decoration into the predetermined orientation. According, the signal of the control system can cause the motor to rotate the mandrel in a specific direction.

Still another aspect of the present invention is a control system to orient and register a decoration on an exterior surface of a metallic container with one or more decorating units of a decorator. The control system includes instructions stored on a non-transitory computer readable medium which, when executed by a processor of the control system, cause the control system to determine an orientation of the decoration with respect to a decorating unit. In one embodiment, the control system uses information received from a least one sensor to determine the orientation of the decoration with respect to the decorating unit. In one embodiment, the metallic container includes a registration mark which is detectable by the sensor. The control system can determine the orientation of the registration mark with respect to the decorating unit. If the decoration is not in a predetermined orientation, the control system can send a signal to align the decorating unit and the decoration in the predetermined orientation. In one embodiment, the signal causes a mandrel upon which the metallic container is positioned to rotate in a specific direction. Additionally, or alternatively, the signal may cause a cylindrical screen of the decorating unit to rotate in a specific direction.

Another aspect of the present invention is an apparatus for applying a decoration to a predetermined portion of a cylindrical exterior surface of a metallic container. The apparatus comprises: (1) a conveyor to transport the metallic container; (2) a feeder to receive the metallic container from the conveyor; (3) a mandrel wheel in a predetermined alignment with respect to the feeder; (4) a plurality of mandrels interconnected to the mandrel wheel to receive metallic containers, each of the mandrels operable to rotate in at least one direction; (5) a sensor to sense an orientation of a first decoration on the cylindrical exterior surface of the metallic container on a mandrel; and (6) a screen decorating unit aligned in a predetermined position with respect to the plurality of mandrels, the screen decorating unit including a cylindrical screen with a first mesh portion, a hollow interior, and a decorating material contained within the hollow interior. In one embodiment, the decorating material is one of an ink, a varnish, and an adhesive. In one embodiment, if the first decoration is not in a predetermined orientation, the mandrel rotates to move the metallic container into the predetermined orientation. In this manner, the decorating material applied to the metallic container by the screen decorating unit is registered with the first decoration in a predetermined alignment.

In one embodiment, the first mesh portion has a predetermined shape to transfer the decorating material to a first portion of the cylindrical exterior surface of the metallic container. In another embodiment, the decorating material transferred to the cylindrical exterior surface by the screen decorating unit is in a predetermined alignment with respect to the first decoration. In one embodiment, the screen decorating unit does not transfer the decorating material to a second portion of the cylindrical exterior surface.

In one embodiment, the decorating material is a varnish. Optionally, the screen decorating unit may apply the varnish to at least a portion of the first decoration. In another embodiment, the varnish may overlap all of the first decoration. In still another embodiment, the varnish does not overlap the first decoration.

In another embodiment, the decorating material is an ink. In one embodiment, the screen decorating unit applies the ink to the cylindrical exterior surface such that the ink forms a second decoration. In one embodiment, the ink does not overlap the first decoration.

In one embodiment, the apparatus includes a control system. The control system is operable to control each of the plurality of mandrels. In one embodiment, the control system receives information from the sensor. The control system can determine if the first decoration is in the predetermined orientation. If the first decoration is not in the predetermined orientation, the control system can determine an amount of rotation required for the mandrel to orient the metallic container in the predetermined orientation. In one embodiment, the control system can send a signal to the mandrel with the metallic container which causes the mandrel to rotate in a specific direction.

In one embodiment, if the first decoration is not in the predetermined orientation, the control system may send a signal to the screen decorating unit. In response to the signal, the cylindrical screen of the screen decorating unit rotates to align the first mesh portion into the predetermined alignment with respect to the first decoration. In another embodiment, the cylindrical screen includes a second mesh portion spaced from the first mesh portion. Optionally, the second mesh portion has a second shape to form a third decoration on the cylindrical exterior surface of the metallic container.

In another embodiment, the first mesh portion includes a plurality of apertures. Optionally, each of the apertures has a size which is greater than pigments of the ink. In another embodiment, the apertures each have a size greater than about 3 micrometers.

In one embodiment, each mandrel has a mandrel axis which is substantially parallel to an axis of the mandrel wheel. In another embodiment, the cylindrical screen of the screen decorating unit is operable to rotate around a screen axis which is substantially parallel to the axis of the mandrel wheel.

In another embodiment, the second decoration formed by the first mesh portion of the screen decorating unit registers with the first decoration previously applied to the cylindrical exterior surface of the metallic container. In this manner, the second decoration can be selectively positioned in a predetermined location of the metallic container.

Optionally, the apparatus further comprises a cure element to cure decorating material transferred to the metallic container by the screen decorating unit. In one embodiment, the cure element is interconnected to a hub of the mandrel wheel.

In one embodiment, the apparatus further comprises a second screen decorating unit including a second cylindrical screen with a second mesh portion, a hollow interior, and a second decorating material contained within the hollow interior. In one embodiment, the second decorating material is an adhesive. The second screen decorating unit can apply the adhesive to a predetermined portion of the container exterior surface. In another embodiment, the second decorating material is a second varnish such that a first portion of the cylindrical exterior surface receives the first varnish and a second portion of the cylindrical exterior surface receives the second varnish.

Optionally, the apparatus includes a label unit to apply a label to a predetermined portion on the cylindrical exterior surface of the metallic container. In another embodiment, the label unit applies the label to the adhesive applied by the second screen decorating unit.

Additionally, the apparatus may optionally include a third screen decorating unit to selectively apply a third decorating material to a predetermined portion of the cylindrical exterior surface of the metallic container. The third decorating material applied by the third screen decorating unit may be registered with respect to one or more of the first and second decorating materials on the cylindrical exterior surface. In one embodiment, the third decorating material is a varnish. In one embodiment, the third screen decorating unit does not apply the varnish to a second portion of the cylindrical exterior surface. In this manner, a predetermined portion of the cylindrical exterior surface will include a varnish and a second portion will not include the varnish.

Yet another aspect of the present invention is a method of decorating an exterior surface of a cylindrical shaped metallic container in a screen printing process. The method includes one or more of, but is not limited to: (1) providing a cylindrical shaped metallic container; (2) positioning the cylindrical shaped metallic container on a mandrel of a decorator; (3) collecting information on the exterior surface of the cylindrical shaped metallic container; (4) determining, with the collected information, an alignment of the cylindrical shaped metallic container with respect to a cylinder of a screen decoration unit; (5) if the alignment of the metallic container is not in a predetermined orientation with respect to the cylinder, determining an amount of axial rotation required to properly align the cylindrical shaped metallic container and the cylinder; (6) activating a drive unit to rotate at least one of the cylinder of the screen decoration unit and the mandrel with the cylindrical shaped metallic container by the determined amount of axial rotation such that the cylindrical shaped metallic container and the cylinder are aligned in the predetermined orientation; and (7) conveying a decorating material through a mesh portion of the cylinder onto a predetermined portion of an exterior surface of the cylindrical shaped metallic container. Optionally, the decorating material comprises one of an ink, a varnish, and an adhesive.

In one embodiment, the decorating material is an ink which forms a screen decoration on a predetermined portion of the exterior surface. In another embodiment, the decorating material is a varnish. The varnish is conveyed to a selected portion of the exterior surface of the cylindrical shaped metallic container. The varnish provides one of a glossy and a matt finish (or semi-matt finish) to the selected portion of the exterior surface. In another embodiment, the selected portion that receives the varnish is isolated from another portion of the exterior surface which does not include a varnish. In this manner, the exterior surface of the cylindrical shaped metallic container may include varnished and unvarnished portions. The varnished and unvarnished portions may be in a predetermined alignment. Optionally, the varnished and unvarnished portions may be separated or isolated from each other.

In still another embodiment, the decorating material is an adhesive. In one embodiment, a label unit subsequently applies a label to the adhesive. In another embodiment, the label unit is associated with the decorator. In one embodiment, the mesh portion includes apertures that have a minimum dimension of up to about 8 micrometers.

In one embodiment, determining the alignment of the cylindrical shaped metallic container further comprises receiving, by a control system of the decorator, the information collected by the sensor. The control system then determines the alignment of the cylindrical shaped metallic container with respect to the cylinder.

In another embodiment, the method further comprises moving the mandrel proximate to a second cylinder of a second screen decoration unit. The method may also include determining an alignment of the cylindrical shaped metallic container with respect to the second cylinder. In one embodiment, if the alignment of the metallic container is not in a predetermined orientation with respect to the second cylinder, the method can further include determining an amount of axial rotation required to properly align the cylindrical shaped metallic container and the second cylinder. In another embodiment, the method can include activating a drive unit to rotate at least one of the second cylinder of the second screen decoration unit and the mandrel with the cylindrical shaped metallic container by the determined amount of axial rotation such that the cylindrical shaped metallic container and the second cylinder are aligned in the predetermined orientation. Optionally, a second decorating material may be conveyed through a second mesh portion of the second cylinder to the exterior surface of the cylindrical shaped metallic container. In one embodiment, the second decorating material is registered with at least one previously applied decoration. In another embodiment, the second decorating material is registered with the decorating material conveyed to the exterior surface by the cylinder of the screen decoration unit. In one embodiment, the second decorating material is a second ink which forms a second screen decoration. In another embodiment, the second decorating material is a second varnish.

In one embodiment, the cylindrical shaped metallic container includes a first decoration applied to the exterior surface before the cylindrical shaped metallic container is positioned on the mandrel of the decorator. By rotating the mandrel by the determined amount, the decorating material conveyed by the screen decoration unit may be registered with the first decoration.

Still another aspect of the present invention is a non-transitory computer readable medium stored on a storage medium and having instructions that when executed by a processor of a control system cause the processor to perform a method of orienting and registering a decoration on an exterior surface of a metallic container with a screen print unit of a decorator. The instructions include one or more of, but are not limited to: (1) instructions to receive information from a sensor related to an orientation of the metallic container positioned on a mandrel of the decorator; (2) instructions to determine an alignment of the decoration on the metallic container with respect to a screen print unit of the decorator; (3) instructions to determine an amount of rotation required to align the metallic container and a cylindrical screen of the screen print unit in a predetermined orientation; and (4) instructions to send a signal to a drive unit of at least one of the cylindrical screen and the mandrel, wherein, in response to receiving the signal, the drive unit rotates at least one of the cylindrical screen and the mandrel with the metallic container thereon in a specific direction. In this manner, a decorating material can be transferred from a hollow interior portion of the cylindrical screen to a predetermined select portion of the exterior surface of the metallic container.

In one embodiment of the present invention, the instructions further comprise an instruction to send a signal to the screen print unit to transfer a decorating material from a hollow interior portion of the cylindrical screen to a predetermined portion of the exterior surface of the metallic container. Optionally, the decorating material is one of an ink, a varnish, and an adhesive. In one embodiment, the cylindrical screen includes a mesh portion of a predetermined size and shape such that the decorating material is transferred to at least a portion of the decoration on the metallic container. In another embodiment, the mesh portion is of a predetermined size and shape such that the decorating material is not transferred to the decoration on the metallic container.

In one embodiment, the predetermined portion of the container exterior surface corresponds to at least a portion of the decoration. In this manner, the cylindrical screen is operable to transfer a varnish or another decorating material to at least a portion of the decoration. In another embodiment, the predetermined portion of the container exterior surface is distinct from the decoration. Accordingly, the cylindrical screen is operable to transfer a varnish or another decorating material that does not overlap the decoration.

Although generally referred to herein as “metallic container,” “beverage container,” “can,” and “container,” it should be appreciated that the current invention may be used to decorate containers of any size or shape including, without limitation, beverage cans, beverage bottles, and aerosol containers. Accordingly, the term “container” is intended to cover containers of any type for any product. The containers may also be in any state of manufacture and may be formed by a draw and ironing process or by an impact extrusion process. Thus, the current invention may be used to decorate “a cup” that is subsequently formed into a finished container, a “bottle preform” that is subsequently formed into a metallic bottle, or a “tube” that is formed into an aerosol container body.

The terms “metal” or “metallic” as used hereinto refer to any metallic material that may be used to form a container, including without limitation aluminum, steel, tin, and any combination thereof. However, it will be appreciated that the apparatus and method of the present invention may be used to decorate containers formed of any material, including paper, plastic, and glass.

The phrase “silk screen apparatus,” “silk screen unit,” and “screen print unit” are used herein to refer to an apparatus that includes a screen used to apply ink to a surface of a substrate such as a metallic container. The screen may include silk or any other suitable material, including natural and synthetic fibers, including fibers of nylon and polyester. Optionally, the screen may include metal fibers. The screen can include a plurality of fibers forming a mesh. The mesh may have apertures of any desired size. In one embodiment, the apertures have a size related to a diameter of pigments within the ink. Accordingly, the apertures may have a size not less than the diameter of pigments of the ink.

As used herein, decorating comprises one or more of varnishing, lacquering, labeling, foil embossing, laser marking, inkjet printing, or screen print printing a container.

The phrase “specialty inks” used herein may include, but is not limited to, one or more colors or types of pigmented ink, thermochromic ink, photochromic ink, scented thermochromic ink, fluorescent ink, UV ink, black light ink, infrared ink, phosphorescent ink, pressure sensitive ink, tactile ink, thermo-tactile ink, leuco dye, matte ink, scratch and sniff ink, and any other type of ink, dye, or varnish that changes appearance, color, phase, and/or texture in response to temperature changes or exposure to light or pressure.

A “thermochromic ink,” as used herein, may include, but is not limited to, any ink of a first predetermined color that can undergo reversible or irreversible change to a second and/or third predetermined color in response to temperature changes.

As used in the present application, a “photochromic ink” may comprise, but is not limited to, any ink of a first predetermined color that can undergo reversible or irreversible change to a second and/or third predetermined color in response to exposure to light of various wavelengths.

A “scented thermochromic ink,” by way of illustration only, includes, but is not limited to, any ink of any color that releases a predetermined scent in response to temperature changes.

A “fluorescent ink,” as used in the present application, may include, but is not limited to, any ink that absorbs ultraviolet energy (light) of various wavelengths and, in response, transmits longer waves in a visible spectrum producing light (or “glow”) in a predetermined color. Fluorescent inks glow under black light and provide a “day glow.”

As used herein, a “phosphorescent ink” includes, but is not limited to, any ink that absorbs light of various wavelengths and produces light of a predetermined color in response. Phosphorescent inks produce light in a manner similar to fluorescent inks; however, phosphorescent inks continue to produce light, or “glow,” once charged by light source even if the light source is removed. Phosphorescent inks may also be known as “glow in the dark ink.”

A “pigmented ink” comprises an ink of any type including pigments of a predetermined size. In one embodiment, the individual pigments of the ink are larger than about 3 micrometers in at least one dimension. In another embodiment, the pigments are larger than about 4 micrometers. In still another embodiment, the pigments are larger than about 6 micrometers. In another embodiment, the pigments are between about 2 micrometers and about 8 micrometers. One example of a pigmented ink includes metallic flakes. However, other types of pigmented ink are contemplated and may be used with the apparatus and device of the present invention.

As used herein, a “black light ink” includes, but is not limited to, any ink that includes a phosphor (or other material) that absorbs energy from UV radiation and, in response, emits visible light.

A “pressure sensitive ink” as used in the present application may include, but is not limited to, any ink of a first predetermined color that can change to a second and/or third predetermined color upon receiving a predetermined amount of pressure. The pressure sensitive ink may include capsules containing inks of different colors. When a pre-determined amount of pressure is applied to the pressure sensitive ink, the capsules rupture and the different colors released from the capsules mix, changing the color of the pressure sensitive ink.

As used in the present application, a “matte ink” may include, but is not limited to, any ink of any predetermined color that has a finish that scatters rays of light more (or has less “gloss”) when applied to a substrate than other non-matte inks (or “glossy” inks) that reflect more light as parallel rays.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary of the Invention, Brief Description of the Drawings, Detailed Description, Abstract, and Claims themselves.

The Summary of the Invention is neither intended, nor should it be construed, as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements or components. Additional aspects of the present invention will become more readily apparent from the Detailed Description, particularly when taken together with the drawings.

### BRIEF DESCRIPTION OF THE DRAWINGS

The accompanying drawings, which are incorporated herein and constitute a part of the specification, illustrate embodiments of the invention and together with the Summary of the Invention given above and the Detailed Description given below serve to explain the principles of these embodiments. In certain instances, details that are not necessary for an understanding of the disclosure or that render other details difficult to perceive may have been omitted. It should be understood, of course, that the present invention is not necessarily limited to the particular embodiments illustrated herein. Additionally, it should be understood that the drawings are not necessarily to scale.

FIG. 1 is a schematic flow diagram of one embodiment of the present invention which depicts a decorator operable to register and decorate metallic containers; and

FIG. 2 is a side elevation view of a decorator of one embodiment of the present invention;

FIGS. 3-4 are perspective views of cylindrical screens of embodiments of the present invention, the first cylindrical screen and the second cylindrical screen including mesh portions;

FIG. 5 is a cross-sectional view taken along line 5-5 of FIG. 4 and illustrating a cylindrical screen in relation to a metallic container;

FIG. 6 is another cross-sectional view of the cylindrical screen and metallic container of FIG. 5 showing a decoration formed on the metallic container by the cylindrical screen;

FIG. 7 is a block diagram of an embodiment of a control system of the present invention; and

FIG. 8 is a process diagram of a method of aligning a metallic container with a decorating unit of a decorator in a high-speed production process according to one embodiment of the present invention.

Similar components and/or features may have the same reference number. Components of the same type may be distinguished by a letter following the reference number. If only the reference number is used, the description is applicable to any one of the similar components having the same reference number. To assist in the understanding of one embodiment of the present invention the following list of components and associated numbering found in the drawings is provided herein:

Number Component
2 Upstream equipment
4 Conveyor
6 Feeder
8 Metallic container
9 Exterior surface of metallic container
10 Decorator
12 Mandrel wheel
14 Mandrel
16 Sensor
18 Cure unit
20 Decorating units
22 Control system
24 Screen print unit
26 Label unit
28 Digital print unit
30 Mandrel wheel axis
32 Drive unit
34 Shaft
36 Hub
38 Mandrel axis
40 Mandrel drive unit
42 Light
44 Cylindrical screen
46 Cylindrical body
48 Closed endwall
50 Hollow interior
52 Decorating material (ink, varnish, adhesive)
54 Rotary drive for cylindrical screen
56 Screen axis
58 Mesh portion
60 Apertures of mesh portion
62 Solid portion
64 Doctor blade
66 Interior surface
70 First decoration
72 Registration mark
74 Second decoration
76 Downstream equipment
80 Bus
82 CPU
84 Input devices
86 Output devices
88 Storage devices
90 Computer readable storage media reader
92 Communication system
94 Working memory
95 Operating system
96 Optional processing acceleration
97 Other code and/or programs
98 Database
100 Network
102 Database
104 Method of aligning a metallic container
106 Start operation
108 Metallic container received by a mandrel
110 Sensor collects or obtains data
112 Determine orientation of a previously applied decoration
114 Determine whether decoration is in a proper orientation
116 Determine an amount of rotation
118 Rotate mandrel and/or a cylindrical screen
120 Apply decorating material to metallic container
122 Optionally cure decorating material
124 Determine if additional decorating material is to be applied
126 Transport metallic container to downstream equipment
128 End operation

### DETAILED DESCRIPTION

The present invention has significant benefits across a broad spectrum of endeavors. It is the Applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment that illustrates the best mode now contemplated for putting the invention into practice is described herein by, and with reference to, the annexed drawings that form a part of the specification. The exemplary embodiment is described in detail without attempting to describe all of the various forms and modifications in which the invention might be embodied. As such, the embodiments described herein are illustrative, and as will become apparent to those skilled in the arts, may be modified in numerous ways within the scope and spirit of the invention.

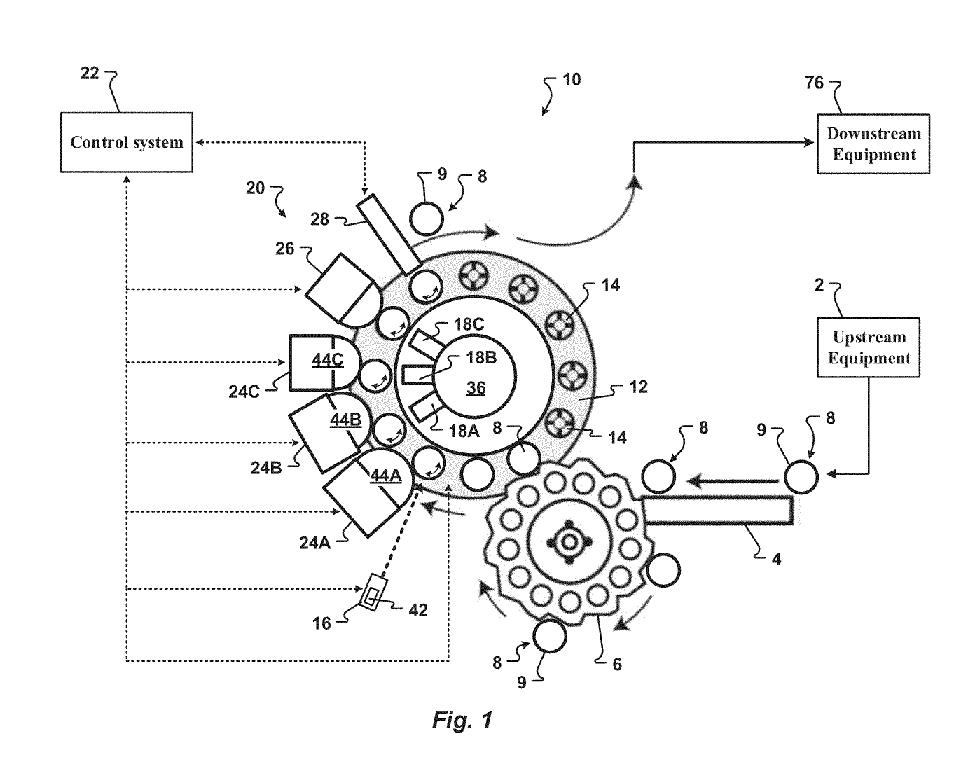

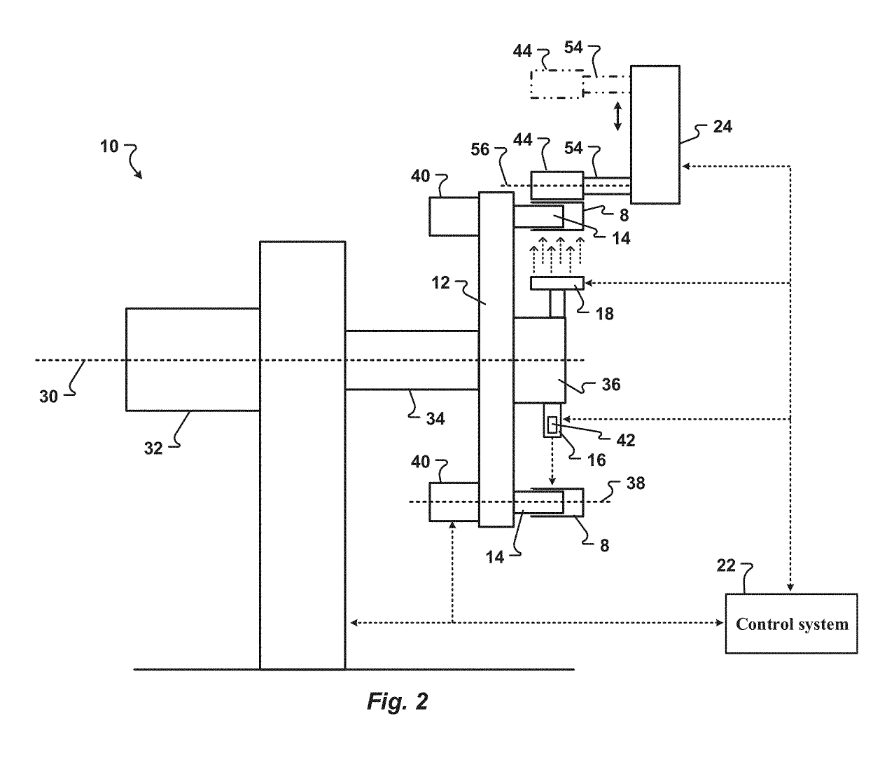

Referring now to FIGS. 1-2, a decorator 10 of the present invention is generally illustrated. The decorator 10 generally receives metallic containers 8 from upstream equipment 2. The metallic containers 8 are transported from the upstream equipment 2 to a feeder 6 by a conveyor 4.

The decorator 10 generally comprises one or more of a mandrel wheel 12, mandrels 14 interconnected to the mandrel wheel 12, sensors 16, curing units 18, decorating units 20, and a control system 22. The decorating units 20 are aligned in predetermined positions with respect to the mandrels 14 of the mandrel wheel 12. The decorating units 20 may include at least one of a screen print unit 24, a label unit 26, and a digital print unit 28. In one embodiment, the decorating units 20 are releasably interconnected to the decorator 10. Accordingly, decorating units may be added to, and removed from, the decorator 10. In this manner, the decorator 10 may be modified for a decoration run to decorate metallic container 8 with unique decorations. Subsequently, the order or number of the decorating units 20 may be change for a second decoration run. Thus, the decorators formed by the decorator may be different in the second decoration run compared to the first decoration run.

Each screen print unit 24 is operable to decorate selected portions of an exterior surface 9 of a metallic container 8 with a variety of different decorations. The label unit 26 is operable to apply labels to the metallic container 8. The labels may be foil labels. In one embodiment, the labels include a paper. The digital print unit 28 can form one of a laser mark and an inkjet image on the metallic container 8.

The metallic container 8 may be a beverage container, such as a beverage can or a beverage bottle, or an aerosol container. The upstream equipment 2 may vary depending on the type of metallic container 8 and the production line used to produce the metallic container. For example, the metallic container 8 may be produced by either a draw and iron production line or an impact extrusion line.

In a draw and iron production line, the upstream production equipment may comprise one or more of bodymakers, trimmers, washers, ovens, basecoaters, additional ovens, printers, and accumulators. The bodymakers form the body of the metallic container 8 into a predetermined diameter and shape. Trimmers trim an open end of the container body to a uniform height. The washers and ovens clean and dry the container body. The basecoaters apply a base layer of ink to the exterior surface of the container body if required for a final decoration design. Additional ovens cure the ink of the base layer. The printers may form a decoration on the metallic container 8 and, optionally, apply a lacquer over the decoration. Optionally, the printers may apply a registration mark to a predetermined portion of the container body. An example of a known draw and iron metallic container production line is generally illustrated and described in “Inside a Ball Beverage Can Plant,” available at http://www.ball.com/Ball/media/Ball/Global/Downloads/How_a_Ball_Metal_Beverage_Can_Is_Made.pdf?ext=.pdf (last visited Apr. 30, 2016) which is incorporated herein by reference in its entirety.

In an impact extrusion production line, the upstream equipment 2 may comprise one or more of an impact extrusion apparatus, a wall ironing station, and a dome former that form and shape the metallic container. A brushing apparatus and washing stations may then clean the exterior and interior surfaces of the metallic container 8. Coaters then apply interior coatings and base coatings to the metallic container. One or more curers may cure each of these coatings. A printer then applies a decoration to the exterior surface of the metallic container body. Optionally, the printers may print a registration mark on a predetermined portion of the container body. The decoration may optionally be cured by another curer. A varnish unit may optionally apply an over-varnish or lacquer to the decorated metallic container 8. An additional curer may then cure the over-varnish.

Optionally, in one embodiment, the upstream equipment 2 in an impact extrusion production line may include dies that form a neck with a decreased diameter proximate to the open end of the metallic container. The upstream equipment 2 may also include tools and dies that shape the body of the metallic container 8 before or after the decorations are applied to the metallic container. Methods and apparatus of forming and decorating metallic containers in an impact extrusion production line are described in U.S. Patent Application Publication No. 2013/0068352 and U.S. Patent Application Publication No. 2014/0298641 which are each incorporated herein by reference in their entirety.

In one embodiment, the upstream equipment 2 comprises an accumulator. The accumulator, in one embodiment, is a mechanical sponge that controls the flow of the container bodies between the upstream equipment and the decorator 10. The accumulator maintains the proper speed and flow of the metallic containers 8 to ensure a consistent, non-interrupted flow of metallic containers into the conveyor 4. The accumulator accumulates metallic containers 8 from the upstream equipment 2 to ensure the decorator 10 is supplied with metallic containers if the upstream equipment goes offline, for example, for maintenance or during unscheduled stops of the upstream equipment.

The feeder 6 receives the metallic containers 8 from the conveyor 4 and conveys the metallic containers to the mandrel wheel 12. In one embodiment, the feeder 6 has a shape that is generally cylindrical. In one embodiment, the feeder 6 includes stations to receive metallic containers 8. Optionally, the feeder 6 rotates in a first direction. In another embodiment, the feeder 6 does not rotate.

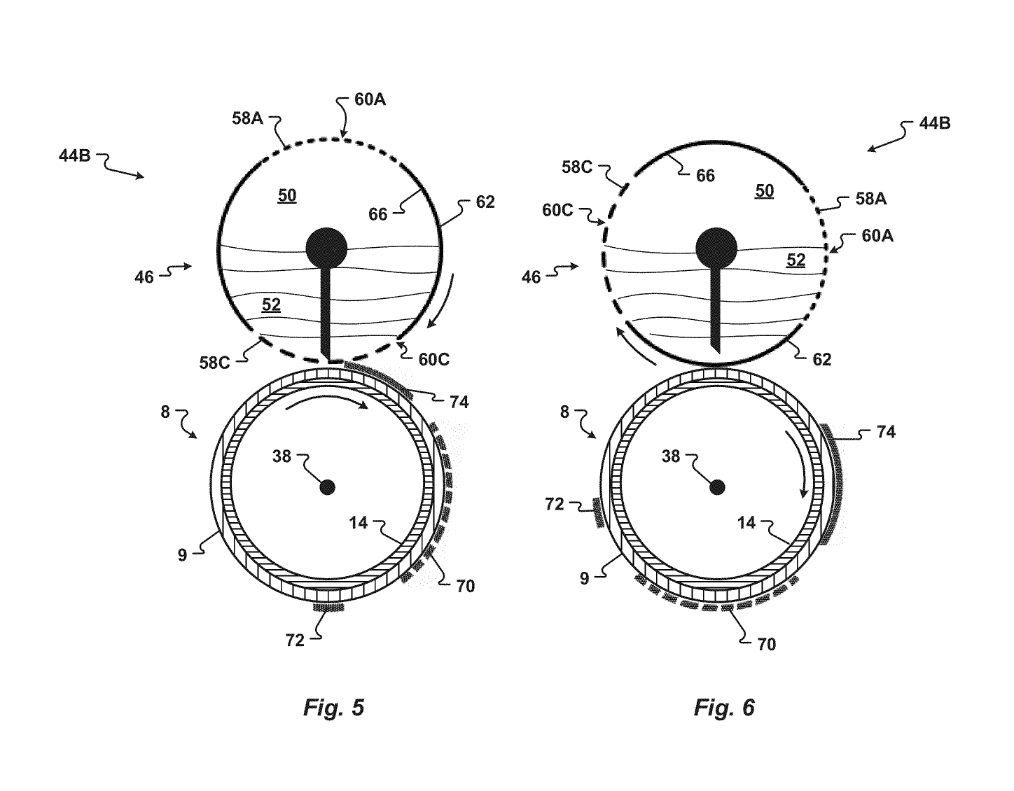

In one embodiment, a predetermined portion of the exterior surface 9 of the metallic container 8 includes a first decoration 70 (illustrated in FIGS. 5-6) previously applied by an upstream printer. The metallic containers 8 arrives at the feeder 6 with the first decoration 70 randomly oriented with respect to the decorating units 20 of the decorator 10.

The mandrel wheel 12 is arranged to receive metallic containers 8 from the feeder 6. Each metallic container 8 is received from the feeder 8 by a mandrel 14 interconnected to the mandrel wheel 12. In one embodiment, the mandrels 14 create a vacuum to draw a metallic container 8 onto the mandrel. The mandrels 14 may include at least one vacuum duct connected to a source of vacuum. The vacuum duct is opened to draw the metallic container 8 from the feeder 6 onto the mandrel 14. After the metallic container is decorated, the vacuum duct is closed to release the metallic container 8 from the mandrel 14.

Optionally, a metallic container is arranged on a mandrel 14 in a predetermined orientation. For example, in one embodiment, a predetermined portion of an exterior surface of the metallic container 8 may be aligned in a selected orientation with respect to the mandrel 14.

The mandrel wheel 12 is operable to rotate around an axis 30. In one embodiment, the mandrel wheel 12 rotates around the axis 30 in the first direction similar to the feeder 6. However, in another embodiment, the mandrel wheel 12 and the feeder 6 rotate in opposite directions.

In one embodiment, the mandrel wheel 12 rotates in indexed steps. More specifically, a drive unit 32 which is interconnected to the mandrel wheel 12 by a shaft 34, rotates the mandrel wheel 12 by a predetermined amount. The drive unit 32 then stops movement of the mandrel wheel 12 for a predetermined period of time. The mandrel wheel 12 remains stationary for a sufficient duration to permit application of a decoration or indicia by a decorating unit 20 and/or curing by a curer 18. At the end of the predetermined period of time, the drive unit 32 rotates the mandrel wheel 12 by another predetermined amount. In one embodiment, a hub 36 of the mandrel wheel 12 does not rotate.

The mandrels 14 are arranged around the mandrel wheel 12. Optionally, the mandrels 14 are substantially evenly spaced on the mandrel wheel 12. In one embodiment, the mandrels 14 have a shape that is generally cylindrical. In another embodiment, a mandrel 14 is at least partially received within a hollow interior of the metallic container 8 as generally illustrated in FIG. 2. One of skill in the art will appreciate that the mandrel wheel 12 may include any number of mandrels 14. In one embodiment, the mandrel wheel 12 includes twelve mandrels 14. However, in another embodiment, the mandrel wheel 12 includes from four to thirty-six mandrels 14.

Each mandrel 14 may selectively rotate around a mandrel axis 38. In one embodiment, the mandrel axis 38 is substantially parallel to the mandrel wheel axis 30 of the mandrel wheel 12. In one embodiment, a drive unit 40 is associated with each mandrel 14 to selectively rotate the mandrel around the mandrel axis 38. The drive unit 40 of each mandrel is operable to selectively rotate a metallic container 8 axially by a predetermined amount at a predetermined rate. Said another way, each drive unit 40 can independently start rotation of an associated mandrel 14 at a predetermined point, select a rate of rotation of the mandrel 14, and stop the rotation of the mandrel 14 after a predetermined amount of time or rotation. In this manner, the drive unit 40 registers decorations applied to the exterior surface 9 of the metallic container 8 with the decorating units 20. In one embodiment, each drive unit 40 can rotate each mandrel 14 in at least one of the first and the second direction. Any appropriate drive unit 40 can be used. In one embodiment, the drive unit 40 is a servo motor. In another embodiment, the drive unit 40 is a torque motor. In one embodiment, rotation of the mandrels 14 is controlled by signals from the control system 22.

In one embodiment, the mandrels 14 include a lock to prevent unintended or inadvertent rotation or movement of the metallic container 8 with respect to the mandrel 14. In this manner, the position of the metallic container is kept constant once the metallic container 8 is positioned on the mandrel 14. In one embodiment, the lock may apply a force to at least one of an exterior and an interior surface of the metallic container 8. Optionally, the lock may include a suction force.

The sensor 16 is oriented to sense the exterior surface 9 of the metallic container 8 and relative positions of the container and decorations on the metallic container. Accordingly, in one embodiment, the sensor 16 determines a position of the first decoration 70 on the metallic container 8. Optionally, the first decoration 70 may be associated with a registration mark 72 formed on the metallic container 8 by a printer of the upstream equipment 2. The registration mark 72 may be of any shape or size. In one embodiment, the sensor 16 detects a feature or landmark of the first decoration 70 on the exterior surface 9 of the metallic container 8. The sensor 16 sends data related to the position of at least one of the first decoration 70 and the registration mark 72 to the control system 22.

Although only one sensor 16 is illustrated in FIG. 1, it will be appreciated by one of skill in the art that any number of sensors may be used with the decorator 10 of the present invention. In one embodiment, a sensor 16 is associated with each mandrel 14. In another embodiment, a plurality of sensors 16 are fixed with respect to the mandrel wheel 12. For example, the sensors 16 may be positioned on the hub 36 of the mandrel wheel 12. Optionally, in another embodiment, the sensors 16 may be positioned on the mandrel wheel 12 proximate to each mandrel 14. In still another embodiment, the sensors may be positioned externally with respect to the mandrel wheel 14. Said another way, the sensors may be positioned outward of a path of movement of the mandrels 14 as generally illustrated in FIG. 1.

Any suitable sensor 16 that can detect decorations 70 and/or registration marks 72 on an exterior surface 9 of a metallic container 8 may be used with the decorator 10 of the present invention. In one embodiment, the sensor 16 comprises an optical or visual sensor. In another embodiment of the present invention, the sensor 16 comprises a high-speed camera. Features of the sensor 16, such as optics, resolution, magnification, and shutter can optionally be controlled by the control system 22.

In one embodiment, the metallic container 8 is rotated around the mandrel axis 38 such that one sensor 16 can obtain or collect data from the entire exterior surface 9 of the metallic container 8. However, any number of sensors may be used with the decorator 10 of the present invention. In one embodiment, the decorator 10 includes three to five sensors arranged around the metallic containers. In this manner, the cylindrical body of the metallic container 8 may be sensed in one operation. Said differently, the three to five sensors 16 are positioned to sense the cylindrical body of each metallic container 8 substantially simultaneously.

In one embodiment, the decorator 10 includes three sensors that each sense about one-third of the cylindrical body of the metallic container 8. In another embodiment, the decorator 10 includes four sensors that each sense about one-fourth of the cylindrical body. In still another embodiment, five sensors 16 of the decorator 10 each sense about one-fifth of the cylindrical exterior surface 9 of the metallic container 8. In one embodiment, the three to five sensors 16 are substantially evenly spaced around the cylindrical exterior surface 9 of the metallic container.

Optionally, at least one light 42 can be associated with the sensor 16. In one embodiment, the light 42 is operable to provide a strobe illumination such that an associated sensor may obtain data from moving metallic containers 8. The operation of the light 42 may be controlled by the control system 22. In this manner, illumination generated by the light 42 is timed with data collection of the sensor 16. In one embodiment, the light comprises at least one of an incandescent lamp, an LED, a high intensity light, a laser, a fluorescent light, and an arc discharge lamp. The light 42 is selected to generate illumination of a predetermined wavelength based on the requirements of the sensor 16.

Optionally, one or more angles of illumination may be provided by the at least one light. In another embodiment, the light 42 includes two or more lights arranged at different angles with respect to the metallic container 8. For example, in one embodiment, a first light 42 may be positioned at an angle of about 90° above the metallic container 8. In another embodiment, a second light 42 is positioned at an angle of between about 10° and about 90° or between about 1° and about 10° with respect to the metallic container 8. Accordingly, the angle of the light with respect to the metallic container 8 may be selected such that the decoration, which may include a variety of heights extending from the cylindrical exterior surface 9 of the metallic container, reflect light differently than other portions of the exterior surface of the metallic container.

The control system 22 is operable to receive the data from the sensor 16. By employing the data received from the sensor, the control system 22 can register the orientation of the first decoration 70 of the metallic container 8 with decorating units 20 of the decorator 10. More specifically, the control system 22 can determine if the first decoration 70 is aligned in a predetermined orientation with respect to the decorating units 20. If the control system 22 determines the first decoration 70 is not aligned in the predetermined orientation, the control system 22 is operable to determine an amount to rotate at least one of the mandrel 14 with the metallic container 8 positioned thereon and a cylindrical screen 44 of a decorating unit 20 to align the first decoration 70 in the predetermined orientation. By rotating the mandrel 14 holding the metallic container 8, a desired portion of the exterior surface 9 of the metallic container 8 may be arranged proximate to one or more of the decorating units 20 positioned along the path of rotation of the mandrel wheel 12. The control system 22 can then send a signal to the drive unit 40 or other apparatus associated with the mandrel 14 to rotate the first decoration 70 into the predetermined orientation. Similarly, the control system 22 can send a signal to a rotary drive 54 of a cylindrical screen 44 such that a desired portion of the cylindrical screen is arranged proximate to a predetermined portion of the metallic container 8.

When the first decoration 70 is in the predetermined orientation, the metallic container 8 may receive another decoration (or a decorating material 52) from one or more decorating units 20 of the decorator 10. A decorating unit 20 may comprise a screen print unit 24. The screen print units 24 include cylindrical screens 44.

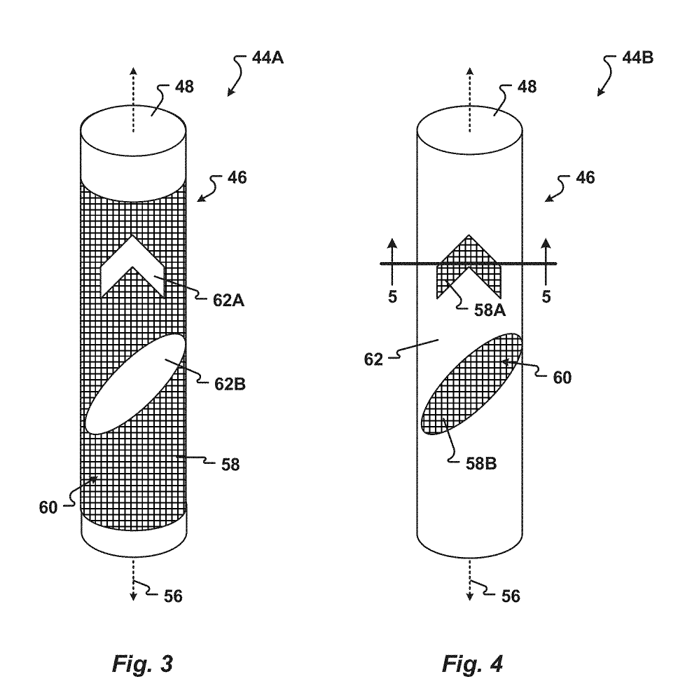

Referring now to FIGS. 3-6, a cylindrical screen 44 of a screen print unit 24 generally includes a cylindrical body 46, closed endwalls 48, and a substantially hollow interior portion 50. A decorating material 52, such as an ink, a varnish, and an adhesive, is held within the hollow interior 50. In one embodiment, at least one of the closed endwalls 48 includes an aperture to receive the decorating material 52 from an ink source. Similar to gravure printing, the cylindrical screen 44 meters the decorating material 52 out of the hollow interior 50 directly onto an exterior surface 9 of a metallic container 8.

In one embodiment, each cylindrical screen 44 is associated with a rotary drive 54 (illustrated in FIG. 2). The rotary drive 54 is in communication with the control system 22. The control system 22 can control the rate of rotation of the cylindrical screen 44 about a screen axis 56. In one embodiment, the control system 22 can send a signal to the rotary drive 54 such that the cylindrical screen 44 rotates at substantially the same rate as a mandrel 14 that is positioned proximate to the screen print unit 24. In one embodiment, the control system 22 may send a signal to the rotary drive 54 to rotate the cylindrical screen 44 in a specific direction such that a specific portion of the cylindrical screen 44 is in a predetermined alignment with a decoration on the metallic container 8.

In one embodiment, the cylindrical screens 44 are aligned with the mandrel wheel 12 such that the screen axis 56 is substantially parallel to the mandrel axes 38. Additionally, in one embodiment, the cylindrical screens 44 are positioned to contact an exterior surface 9 of a metallic container 8 positioned on a mandrel 14. In one embodiment, the cylindrical screen 44 rotates around the screen axis 56 substantially parallel to the mandrel wheel axis 30 and the axes 38 of each of the mandrels 14. In one embodiment, the cylindrical screen 44 can rotate in at least one of the first and the second direction. In this manner, the cylindrical screen 44 can make rolling or rotary contact with an exterior surface 9 of a metallic container 8 positioned on a mandrel 14.

In one embodiment, the cylindrical screens 44 of the screen print units 24 are substantially stationary with respect to the mandrels 14. In another embodiment, the cylindrical screens 44 are movable in relation to the mandrels 14. For example, in one embodiment, the cylindrical screens 44 may be movably positioned relative to the mandrel wheel 12. Accordingly, the cylindrical screens 44 may move closer to and away from the mandrel wheel 12 and mandrels 14 thereon, as generally illustrated in FIG. 2. In one embodiment, the cylindrical screens 44 may be moved in a direction generally parallel to a radius of the mandrel wheel 12. In this manner, when a mandrel 14 with a metallic container 8 is positioned in a predetermined positioned proximate to a cylindrical screen 44, the exterior surface of the cylindrical screen 44 may be brought into engagement with the exterior surface 9 of the metallic container 8.

At least a portion of the cylindrical body 46 of the cylindrical screen 44 includes a mesh portion 58 with a plurality of apertures 60. The apertures 60 of the mesh portions 58 have a predetermined size. In one embodiment, the apertures 60 of the mesh portions 58 are selected to be larger than pigments in the ink 52. The decorations produced by the cylindrical screens 44 are defined by the mesh portions 58 and the apertures 60 through which the ink or other decorating material 52 is forced or flows. The mesh portion may be formed of at least one of threads, fibers, and metallic wire of any suitable material. The threads or fibers may be of a natural material or a manmade material. In one embodiment, the threads may be formed of silk.

In one embodiment, the cylindrical body 46 is formed at least partially of a photopolymer material. A mesh portion 58 may be formed on the cylindrical body 46 with a computer to plate (CTP) process, a conventional plate exposure process, or any other suitable method. More specifically, the mesh portion 58 may be formed on a sheet that will be formed into a cylinder. The sheet may comprise a photopolymer material. In a CTP process, a decoration may be transferred directly onto the sheet of photopolymer material in a digital imager apparatus as will be appreciated by one of skill in the art. The digital imager apparatus ablates, or otherwise removes, portions of an opaque mask coating on the sheet to form a negative of the decoration. The sheet of photopolymer material is then placed into an exposure device that exposes the sheet to a light source. Portions of the mask coating that were not ablated block light and prevent the light from reaching the photopolymer material of the sheet. The photopolymer material under remaining portions of the mask coating remains unexposed and soft. The sheet is cleaned to remove the soft, unexposed portions of photopolymer material which creates a mesh portion 58. The sheet may then be formed into a cylinder to create a cylindrical screen 44.

Using a conventional plate exposure process, a film negative of a decoration may be placed on a predetermined portion of the sheet of photopolymer material. The sheet with the film negative is then placed into an exposure device that exposes the photopolymer material and the film negative to a light source. The film negative acts as a negative mask that blocks and prevents some of the light from reaching portions of the photopolymer material of the sheet. The light shines through the clear sections of the film negative and hardens the photopolymer material of the sheet. The photopolymer material under the areas of the film negative that block the light, or some of the light, remain unexposed and soft. The film negative is then removed from the sheet and the sheet is cleaned to remove the soft, unexposed portions of photopolymer material. The sheet may then be formed into a cylinder to create a cylindrical screen 44.

Portions of the cylindrical body 46 which do not include a mesh portion are solid 62. Accordingly, ink 52 will not flow out of these solid portions 62 of the cylindrical body 46. Optionally, the cylindrical screens 44 of each screen decorating unit 20 may have a unique arrangement of mesh portions 58. In one embodiment, solid portions 62A of a first cylindrical screen 44A may align with mesh portions 58 of a second cylindrical screen 44B. In this manner, a decorating material 52 applied to a metallic container 8 by the first cylindrical screen 44A may align, or register with, a second decorating material 52 applied to a metallic container 8 by the second cylindrical screen 44B. For example, in one embodiment, a decoration formed by mesh portion 58 of the first cylindrical screen 44A will not be covered by decorations formed by mesh portions 58A, 58B of the second cylindrical screen 44B.

The mesh portions 58 may have any size and shape. Further, mesh portions 58 may be formed at any location on the cylindrical body 46. A mesh portion 58 may have a width that is about equal to, or less than, the circumference of the cylindrical body 46. For example, in one embodiment, a mesh portion 58 may extend along a portion of the circumference of the cylindrical body 46 which is about equal to a circumferential portion of the metallic container 8 to be decorated. Said another way, the mesh portion 58 may have a size and shape substantially equal to a decoration to be formed on the exterior surface 9 of the metallic container 8.

In one embodiment, two or more mesh portions 58 may be formed on a cylindrical screen 44. Each mesh portion 58 may have a different size and shape. In one embodiment a mesh portion 58 may have a length that is less than the length of the cylindrical screen 44. More specifically, a cylindrical screen 44B may include two mesh portions 58A, 58B separated by a solid portion 62.

Referring now to FIG. 5, in one embodiment, the apertures 60 of each mesh portion 58 may have a different size. More specifically, in one embodiment, cylindrical screen 44B includes two mesh portions 58A, 58C which have apertures 60 of different sizes. In this manner, different amounts of decorating material 52 (such as an ink or a varnish) may pass through a first mesh portion 58A compared to a second mesh portion 58C. The first mesh portion 58A includes apertures 60A with a small size. Accordingly, the flow of decorating material through mesh portion 58A may be restricted. Further, large pigments of the decorating material 52 may not pass through the first mesh portion 58A. In contrast, the apertures 60C of the second mesh portion 58C have a greater size than apertures 60A. In this manner, the decorating material may flow through mesh portion 58C at a greater rate than through mesh portion 58A. In one embodiment, larger pigments of the decorating material 52 can pass through the second mesh portion 58C than through mesh portion 58A. In this manner, the first mesh portion 58A may form a decoration with the decorating material 52 that includes small pigments. A second decoration may be formed by decorating material 52 passing through the second mesh portion 58C; however, the size of pigments included in the second image will be greater than the pigments included in the first decoration.

In one embodiment, an ink doctor blade 64 is positioned within the hollow interior 50 of the cylindrical screen 44. Contact of the ink doctor blade 64 with the interior surface 66 of the cylindrical screen 44 causes decorating material 52 to be forced or squeezed out of the hollow interior 50 through the apertures 60 of the mesh portion 58. The decorating material 52 that passes through the mesh portion 58 is transferred to the exterior surface 9 of a metallic container 8 positioned on a mandrel 14.

In one embodiment, the ink doctor blade 64 has a length at least equal to a longitudinal length of the mesh portion 58 of the cylindrical screen 44. Optionally, when the cylindrical screen includes two or more mesh portions 58, a corresponding number of ink doctor blades 64 may be positioned within the hollow interior 50 of the cylindrical screen.

In one embodiment, the ink doctor blade 64 is moveably positioned with respect to the interior surface 66. More specifically, as generally illustrated in FIG. 6, the ink doctor blade 64 may move away from the interior surface 66 at predetermined times or in response to a signal from the control system 22. In one embodiment, the ink doctor blade 64 moves away from the interior surface 66 when a solid portion 62 of the cylindrical screen 44B rotates into contact with the container exterior surface 6.

Referring again to FIG. 5, the ink doctor blade 64 may move into contact with the interior surface 66 at predetermined times or when the cylindrical screen 44 is in a predetermined orientation. Accordingly, in one embodiment, the ink doctor blade 64 may move into contact with the interior surface 66 when the exterior surface of the cylindrical screen 44 moves into contact with an exterior surface 9 of a metallic container 8.

In one embodiment, the ink doctor blade 64 moves in response to a signal from the control system 22. In another embodiment, the movement of the ink doctor blade 64 is mechanically controlled. For example, the ink doctor blade 64 may move in response to action of a cam follower that engages a cam of the cylindrical screen. In this manner, movement of the ink doctor blade 64 may be associated with rotation of the cylindrical screen 44.

Optionally, movement of the ink doctor blade 64 into contact with the interior surface of the cylindrical screen 44 is controlled to correspond to rotation of a mesh portion 58 with respect to an exterior surface 9 of the metallic container 8. Thus, the ink doctor blade 64 moves into contact with the interior surface 66 when a mesh portion 58 of the cylindrical screen 44 rotates into contact with the exterior surface 9 of the metallic container 8. When the mesh portion 58 rotates out of contact with the exterior surface 9, the ink doctor blade 64 moves away from the interior surface 66 of the cylindrical screen 44.

In one embodiment, the size of the apertures 60 of the mesh portion 58 prevents the flow of decorating material 52 through the mesh portion 58. Accordingly, in one embodiment, contact of the ink doctor blade 64 with the interior surface 66 is required for decorating material to flow through the mesh portion 58.

In one embodiment, the cylindrical screens 44 have a diameter that is larger than the diameter of the metallic containers 8. Accordingly, the cylindrical screens 44 do not have to complete a full rotation to transfer a decorating material 52 to the exterior surface 9 of the metallic container 8. Optionally, in another embodiment, the diameter of the cylindrical screens 44 is about equal to the metallic container diameter. In yet another embodiment, the cylindrical screen diameter is less than the metallic container diameter.

The decorating material 52 may comprise one of a predetermined color or type of ink and a varnish to form a decoration on the selected portion of the metallic container body 9. The ink 52 may be any pigmented ink or a specialty ink as described herein. Alternatively, the decorating material 52 may comprise an adhesive that will receive a label applied by the label unit 26.

Some other printing methods, such as offset printing, do not typically transfer a sufficient weight or thickness of a decorating material, such as an ink, to an exterior surface 9 of a metallic container 8 to achieve desired decorations. One of skill in the art will appreciate that a cylindrical screen 44 carries, and can transfer, more decorating material 52 than known offset printing systems. Thus, the cylindrical screen 44 can transfer sufficient amounts of decorating material to selected portions of container exterior surfaces 9 to create decorations that are not possible using other known decorating methods.

In one embodiment of the present invention, the decorating material 52 transferred to the container exterior surface 9 by the cylindrical screen 44 forms a decoration 74 which has a thickness of between about 3 micrometers to about 8 micrometers. In one embodiment, the thickness of the decoration 74 is between about 6 micrometers and about 8 micrometers.

The cylindrical screen 44 can also transfer pigmented ink 52 that cannot be transferred by prior art flexographic printing systems that use an Anilox roller. For example, in one embodiment of the present invention, the cylindrical screen 44 can transfer a pigmented ink with pigments having a diameter of greater than 3 micrometers. In another embodiment, the cylindrical screen 44 can transfer pigmented inks with pigments having a diameter of between about 3 micrometers and about 8 micrometers. In one embodiment, the mesh portion 58 of the cylindrical screen 44 has apertures 60 with no dimension less than about 8 micrometers. In another embodiment, the apertures 60 have a size of between about 3 micrometers and about 8 micrometers.

Referring now to FIGS. 5-6, in operation, as the mandrel wheel 12 rotates, the exterior surface 9 of a metallic container 8 on a mandrel 14 is brought into rotational contact with an exterior surface of a cylindrical screen 44B. The mandrel 14 rotates the metallic container 8 by a predetermined amount and at a predetermined rate. The cylindrical screen 44 rotates at substantially the same rate.

A predetermined type of decorating material 52 flows through a mesh portion 58C from the hollow interior 50 of the cylindrical screen 44 onto the exterior surface 9 of the metallic container 8. In this manner, the cylindrical screen 44 transfers the predetermined decorating material 52 to a selected portion of the container exterior surface 9 to form a decoration 74.

Referring again to FIG. 1, any number of decorating units 20 may be aligned with the mandrel wheel 12. Further, in one embodiment, decorating units 20 may be added to, or removed from, the decorator 10. In one embodiment, the positions of decorating units 20 may be alter. For example, in one embodiment, screen print unit 24C may be positioned move to a position after the digital print unit 28. Optionally, in another embodiment, screen print unit 24C and digital print unit 28 may be moved to positions before screen print unit 24A.

In one embodiment, the decorator 10 includes three screen print units 24A, 24B, 24C that each have a cylindrical screen 44. Each of the screen print units 24 may apply a different predetermined decorating material 52 comprising one of an ink, a varnish, and an adhesive. Further, the decorating material 52 applied by each of the screen print units 24 may be aligned, or registered with, previously applied decorations 70 or portions of the container exterior surface 9 that previously received decorating material.

In one embodiment, the first, second, and third screen print units 24A-24C have first, second, and third cylindrical screens 44A, 44B, 44C. The first cylindrical screen 44A may apply a first decoration 70 to a selected first portion of an exterior surface 9 of a metallic container 8. The first decoration may comprise a first ink or varnish 52. Optionally, the first decoration 70 may be registered with a previous decoration or registration mark 72, when present, that was previously applied by upstream equipment 2, such as an upstream printer.

The second cylindrical screen 44B may apply a second decoration 74 to a selected second portion of the exterior surface of the metallic container 8. The second decoration 74 may comprise a second ink or varnish 52 which may be registered with the first decoration 70 and, optionally, with the previous decoration or registration mark 72.

Continuing this example, the third cylindrical screen 44C may apply a third decoration to a selected third portion of the exterior surface of the metallic container 8. The third decoration may comprise a third ink or varnish 52. The third decoration may be registered with the first and second decorations 70, 74 and, optionally, with the previous decoration or registration mark 72 applied by the upstream equipment. In one embodiment, at least one of the first, second, and third screen print units 24A-24C applies a varnish to the exterior surface 9 of the metallic container 8. The varnish may be registered with any previously applied decoration 70-74. In this manner, a varnish 52 (or over-varnish) may be applied over a previously applied decoration 70-74, or a predetermined portion of the container exterior surface 9, to create a combination of matte and gloss finishes on different portions of the exterior surface. Said another way, the decorator 10 can apply a plurality of different inks and/or varnishes 52 to a metallic container 8 such that the metallic container includes a decoration with a combination of varnished and un-varnished finishes.

In one embodiment, the first screen print unit 24A transfers a first varnish to a first portion of a metallic container 8. A second screen print unit 24B transfers a second varnish to a different second portion of the metallic container 8. In this manner, the first portion of the metallic container may have a glossy finish and the second portion of the metallic container may have a matt or semi-matt finish.

After a decorating unit 20 transfers a decorating material 52 to a metallic container 8, the mandrel wheel 12 may rotate to move the decorated metallic container 8 into alignment with a cure unit 18. The cure unit 18 may be interconnected to the hub 36 of the mandrel wheel 12. In one embodiment, the hub 36 does not rotate. The cure unit 18 may be a UV or UV LED cure element. In one embodiment, a cure unit 18, such as cure unit 18A, is aligned with a radius of the mandrel wheel 12 that does not intersect the cylindrical screens 44. Accordingly, the cure unit 18 is operable to cure the decorating material 52 applied to a container exterior surface 9 without affecting the decorating material on the cylindrical screens 44. This alignment of cure unit 18A prevents curing of the ink or varnish on the cylindrical screens 44. Optionally, the decorator 10 may include a shield to prevent the cure unit 18 from curing decorating material a cylindrical screen. In one embodiment, the shield is generally positioned between the cure unit 18 and a cylindrical screen 44.

In one embodiment, a cure unit 18 may be associated with each screen print unit 24. In this manner, each type of decorating material 52 applied by each screen print unit 24 can be cured before a subsequent screen print unit 24 applies a subsequent decorating material. Alternatively, a single cure unit 18 may be associated with one or more screen print units 24. Thus, when the decorator 10 includes three screen print units 24A-24C, each screen print unit may apply a decorating material 52 before the single cure unit 18 cures the three decorating materials applied by the three cylindrical screens 44A-44C. In another embodiment, a curing unit may be associated with each decorating unit 20 that applies a decorating material 52 that requires curing.

In one embodiment, a cure unit 18B is aligned such that a mandrel 14 is positioned between the cure unit 18B and a cylindrical screen 44C during curing of a decorating material 52 on a metallic container. In this manner, the mandrel 14 and the metallic container 8 shield the cylindrical screen 44C from curing energy supplied by the cur unit 18B.

The decorator 10 may also include a label unit 26. The label unit 26 can apply foil or labels to an exterior surface 9 of a metallic container 8. In one embodiment, the label unit 26 includes a foil stamp that rotates. A foil or label applied to a metallic container 8 by the label unit 26 may be registered with any previously applied decorations 70-74. The foil or labels may be used to create metallic or other special effects on exterior surfaces 9 of metallic containers 8.

In one embodiment, when the decorator 10 includes a label unit 26, a screen print unit 24 can apply an adhesive 52 to a predetermined portion of a container exterior surface 9. A mandrel 14 with the metallic container 8 then rotates into a predetermined alignment with the label unit 26. The label unit 26 then applies a label to the previously applied adhesive. Alternatively, in another embodiment, the label unit 26 may apply a label that is self-adhesive to the metallic container. For example, in one embodiment, the label may have an adhesive backing. In another embodiment, the label unit 26 may apply an adhesive to the label. In this manner, a screen print unit with an adhesive decorating material is not required to be associated with the label unit 26.

Additionally, in one embodiment, the decorator 10 also includes at least one digital print unit 28. The digital print unit 28 is operable to apply a unique decoration or indicia to each metallic container 8. In one embodiment, the digital print unit 28 includes a laser to form a mark on the exterior surface 9 of a metallic container 8. In another embodiment, the digital print unit 28 includes an inkjet print head. The decorator 10 may include any number of digital print units 28. In one embodiment, the decorator 10 includes from one to four digital print units. Optionally, the digital print unit 28 may be positioned to decorate a metallic container 8 before or after at least one of a screen print unit 24 and a label unit 26 applies a decoration to the metallic container 8.

The laser of the digital print unit 28 may include one or more Nd:YAG lasers (also known as neodymium-doped yttrium aluminum garnet lasers) with a wavelength of approximately 1.064 μm. In one embodiment, the laser provides an output from about 40 Watts to about 140 Watts of applied power, with about 80% of such power being delivered to a target area of the container exterior surface. In another embodiment, the laser provides a pulsed or intermittent form of laser light. In one embodiment, the laser can provide pulses at from approximately 3,000 Hz to approximately 65,000 Hz. Preferably the output laser light pulses are relatively stable in the sense that there is relatively little variation in power from one pulse to the next and substantially all pulses have sufficient power to vaporize or ablate the material of the target area of the container exterior surface sufficiently to produce a visible spot or mark. In still another embodiment, the laser is operable to mark approximately 1,300 characters per second. Lasers that can be used in this regard are known by those of skill in the art and are available from a variety of suppliers.

After all decorations have been applied to the exterior surface 9 of a metallic container 8 and, optionally, cured by cure units 18, the mandrel wheel 12 continues rotating to an outfeed position. At the outfeed position, the decorated metallic containers 8 are separated from the mandrels 14 of the mandrel wheel 12 and conveyed to downstream equipment 76. In one embodiment, the downstream equipment 76 includes one or more of a coater, an oven, a waxer, a die necker, a tester, an inspection station, and a palletizer. The coater applies a lacquer (or other material) to the interior of the container. The oven cures the lacquer. A thin layer of a lubricant may be applied by a waxer to a portion of the container body proximate to an open end of the metallic container. The die necker reduces the diameter of a portion of the metallic container body and applies a curl to aerosol containers. The tester checks the container for unintended apertures or leaks. The inspection station may check the location and quality of the decoration. The palletizer can bundle the finished metallic containers for shipment or storage.

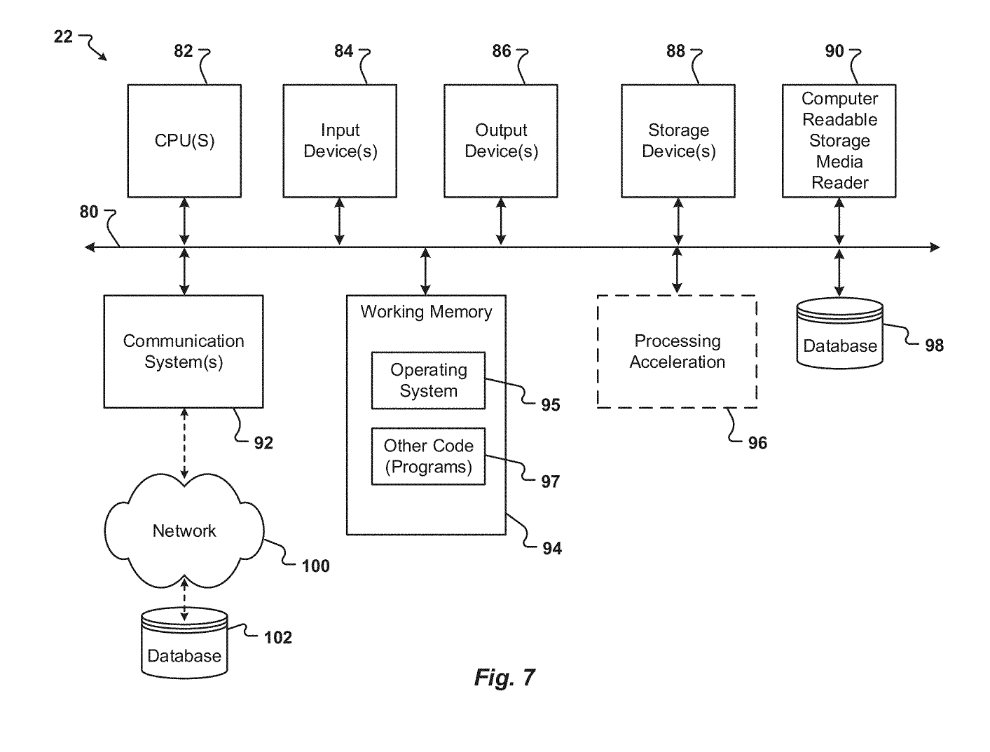

Referring now to FIG. 7, a control system 22 of one embodiment of the present invention is generally illustrated. More specifically, FIG. 7 illustrates one embodiment of a control system 22 of the present invention. The control system 22 is operable to align a decoration 70-74 on a metallic container 8 with a decorating unit 20 of a decorator 10. The control system 20 is generally illustrated with hardware elements that may be electrically coupled via a bus 80. The hardware elements may include one or more central processing units (CPUs) 82; one or more input devices 84 (e.g., a mouse, a keyboard, etc.); and one or more output devices 86 (e.g., a display device, a printer, etc.). The control system 22 may also include one or more storage devices 88. In one embodiment, the storage device(s) 88 may be disk drives, optical storage devices, solid-state storage device such as a random access memory (“RAM”) and/or a read-only memory (“ROM”), which can be programmable, flash-updateable and/or the like.

The control system 22 may additionally include one or more of a computer-readable storage media reader 90; a communications system 92 (e.g., a modem, a network card (wireless or wired), an infra-red communication device, etc.); and working memory 94, which may include RAM and ROM devices as described above. In some embodiments, the control system 22 may also include a processing acceleration unit 96, which can include a DSP, a special-purpose processor and/or the like. Optionally, the control system 22 also includes a database 98. The database may include information related to locations of decorations applied to metallic containers 8 by upstream equipment. Additionally, or alternatively, the database 98 can include information on a preferred orientation of an exterior surface 9 of a metallic container 8 in relation to a decorating unit 20 of the decorator. In this manner, the control system 22 can determine when a decoration 70, 72, 74 on the exterior surface 9 is properly oriented to a decorating unit 20 using data received from a sensor 16.

The computer-readable storage media reader 90 can further be connected to a computer-readable storage medium, together (and, optionally, in combination with storage device(s) 88) comprehensively representing remote, local, fixed, and/or removable storage devices plus storage media for temporarily and/or more permanently containing computer-readable information. The communications system 92 may permit data to be exchanged with a network 100 and/or any other data-processing. Optionally, the control system 22 may access data stored in a remote storage device, such as database 102 by connection to the network 100. In one embodiment, the network 100 may be the internet.

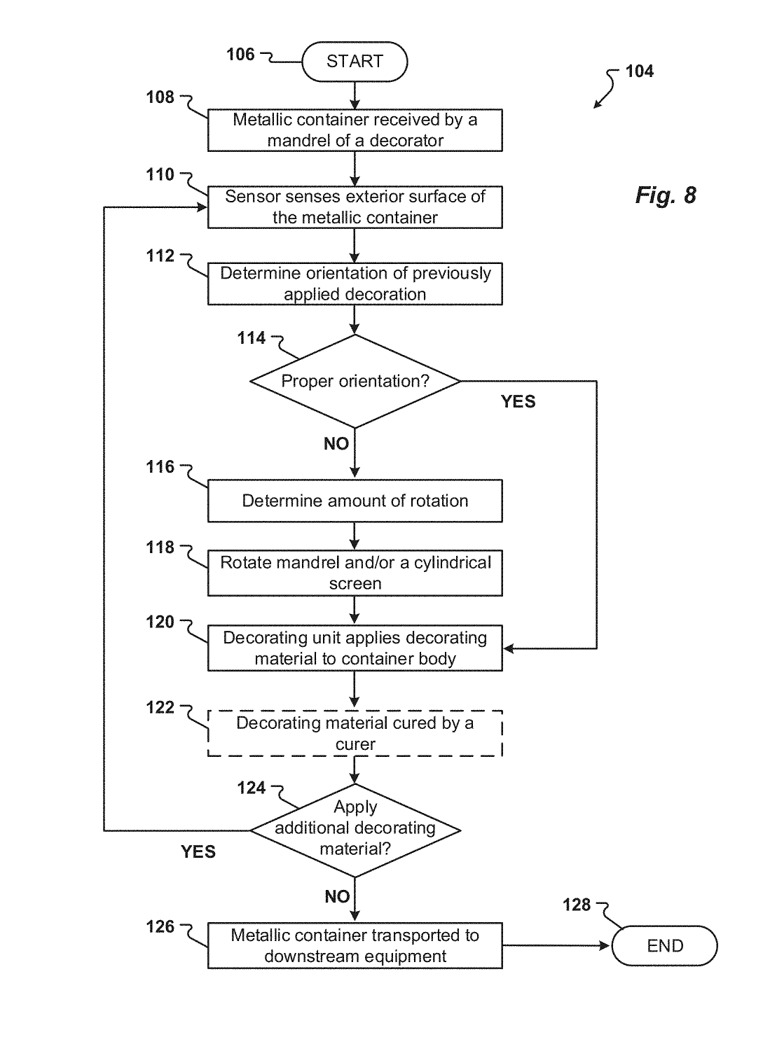

The control system 22 may also comprise software elements, shown as being currently located within the working memory 94. The software elements may include an operating system 95 and/or other code 97, such as program code implementing one or more methods and aspects of the present invention. In one embodiment, instructions to perform the operations of method 104 described in conjunction with FIG. 8 are stored in the working memory 94.

One of skill in the art will appreciate that alternate embodiments of the control system 22 may have numerous variations from that described above. For example, customized hardware might also be used and/or particular elements might be implemented in hardware, software (including portable software, such as applets), or both. Further, connection to other computing devices such as network input/output devices may be employed.

In one embodiment, the control system 22 is a personal computer, such as, but not limited to, a personal computer running the MS Windows operating system. Optionally, the control system 22 may be a smart phone, a tablet computer, a laptop computer, a desktop computer, and similar computing devices. In one embodiment, the control system 22 is a data processing system which includes one or more of, but is not limited to: at least one input device (e.g. a keyboard, mouse, or touch-screen); at an output device (e.g. a display, a speaker); a graphics card; a communication device (e.g. an Ethernet card or wireless communication device); permanent memory (such as a hard drive); temporary memory (for example, random access memory); computer instructions stored in the permanent memory and/or the temporary memory, and a processor. The control system 22 may be any programmable logic controller (PLC). One example of a suitable PLC is a Controllogix PLC produced by Rockwell Automation, Inc., although other PLCs are contemplated for use with embodiments of the present invention.

Referring now to FIG. 8, an embodiment of a method 104 of one embodiment of the present invention for aligning a decoration on a metallic container 8 with a decorating unit 20 of a decorator 10 in a high-speed production process is illustrated. While a general order of the operations of method 104 is shown in FIG. 8, method 104 can include more or fewer operations, or can arrange the order of the operations differently than those shown in FIG. 8. Further, although the operations of method 104 may be described sequentially, many of the operations may in fact be performed in parallel or concurrently. Generally, method 104 starts with a start operation 106 and ends with an end operation 128. At least a portion of method 104 can be executed as a set of computer-executable instructions executed by a computer system and encoded or stored on a computer readable medium. One example of the computer system may include, for example, the control system 22. An example of the computer readable medium may include, but is not limited to, a memory 88, 94, of the control system 22. Hereinafter, method 104 shall be explained with reference to FIGS. 1-7 and the systems and apparatus described herein.

A metallic container 8 is received by a mandrel 14 of a decorator 10 in operation 108. An exterior surface 9 of the metallic container 8 may optionally include a decoration 70 or a registration mark 72 applied by a printer of upstream equipment 2. In operation 110, a sensor 16 of the decorator 10 collects or obtains data on the container exterior surface 9 to sense the first decoration 70. Optionally, in one embodiment, the sensor senses the registration mark 72. The sensor 16 may comprise a high speed camera or any other optical system that can sense the first decoration or registration mark. The sensor 16 sends data related to the orientation of the metallic container 8 to the control system 22.

In operation 112, the control system 22 uses the information received from the sensor 16 to determine the orientation of the first decoration 70 or registration mark 72. The control system 22 can then determine, in operation 114, if the first decoration 70 or registration mark 72 is aligned in a predetermined orientation with respect to a decorating unit 20 of the decorator 10. In one embodiment, the sensor 16 collects or obtains information on the first decoration 70 which is used by the control system 22 to determine if the first decoration 70 is in the predetermined orientation. In another embodiment, the sensor 16 obtains or collects information on the registration mark 72 on the metallic container 8. The control system 22 can determine the orientation of the first decoration 70 using information received about the registration mark 72. If the first decoration 70 or the registration mark 72 is not in the predetermined orientation, method 104 proceeds NO to operation 116. If the first decoration 70 or the registration mark 72 is in the predetermined orientation, method 104 proceeds YES to operation 120.

The control system 22 can determine an amount of axial rotation necessary to align the metallic container 8 and the decorating unit 20 in operation 116. In one embodiment, the control system 22 determines an amount of axial rotation of the mandrel 14 is required to move the first decoration 70 into the predetermined orientation. The control system 22 can then send a signal to a drive unit 40 associated with the mandrel 14 to rotate the mandrel by the amount of axial rotation required to move the first decoration into the predetermined orientation with respect to a decorating unit 20. Additionally, or alternatively, the control system 22 may also determine an amount of axial rotation of a cylindrical screen 44 of a screen print unit 24 which is required to properly align the cylindrical screen 44 with respect to the first decoration 70 or the registration mark 72 on the container exterior surface 9. The control system 22 can then send a signal to a rotary drive unit 54 associated with the cylindrical screen 44 to rotate the cylindrical screen into the predetermined orientation with respect to the decoration 70 or the registration mark 72 on the container exterior surface 9.

In operation 118, in one embodiment, the drive unit 40 or another mechanism associated with the mandrel 14 rotates the mandrel by the predetermined amount. In this manner, the metallic container 8 positioned on the mandrel 14 is rotated such that the first decoration 70 is in the predetermined orientation with a decorating unit 20. Any suitable drive unit 40, motor, or other device known by those skilled in the art may be used with the mandrels 14 of the present invention. Optionally, the drive unit 40 may rotate in either of a first direction and a second direction in response to the signal received from the control system 22. In one embodiment, the drive unit 40 is a servo motor. In another embodiment, the drive unit 40 is a torque motor.

In another embodiment, the rotary drive unit 54 rotates the cylindrical screen 44 in a predetermined direction in response to a signal received from the control system 22. Accordingly, the control system 22 can cause the cylindrical screen 44 to rotate such that a mesh portion 58 of the cylindrical screen is in a predetermined alignment with respect to a decoration 70 or registration mark 72 on the container exterior surface 9.

When the first decoration 70 and the decorating unit 20 are in the proper orientation, the decorating unit 20 applies a decorating material 52 to the container exterior surface 9 in operation 120. In this manner, the decorating material 52 is registered with the first decoration 70. The decorating unit 20 may comprise one of a screen print unit 24, a label unit 26, and a digital print unit 28. The digital printing unit 28 may comprise one of an inkjet print head and a laser print head.

In one embodiment, the decorating material 52 from the decorating unit 20 is one of an ink, a varnish, and an adhesive. In another embodiment, the decorating material 52 forms a second decoration 74 on the container exterior surface 9. The second decoration 74 is registered with respect to the first decoration 70.

In operation 122, the decorating material, or the second decoration 74, may optionally be cured by a curer 18. In one embodiment, the cure unit 18 generates a light of a wavelength selected to cure or set the decorating material. In one embodiment, the decorating material is an ink which forms the second decoration 74. The cure unit 18 is arranged in a predetermined position such that the energy generated by the cure unit 18 contacts the second decoration 74 on the exterior surface of the metallic container. In another embodiment, the cure unit 18 generates heat to cure or set the ink 52 applied by the decorating unit 20.

It will be appreciated by one of skill in the art that some decorations applied by decorating units 20 of the decorator 10 do not require curing. Other decorations, for example ink decorations applied by two different screen print units 24A, 24B, may be cured by one cure unit 18. In another embodiment, a first ink 52 applied by a first screen print unit 24A may require a different type of energy or wavelength of light to cure compared to a second ink applied by a second screen print unit 24A. Accordingly, a first cure unit 18A that produces a first type of energy (such as a first wavelength of light) may be associated with the first screen print unit 24A and a second cure unit 18B that produces a second type of energy (such as heat or a second wavelength of light) may be associated with the second screen print unit 24A. In yet another embodiment, a first ink 52 of a decoration 70 formed by a first screen print unit 24A may require a different amount of time to cure than a second decoration 74 of a second ink 52 formed by a second screen print unit 24B. In this example, the first cure unit 18A may operate for a different amount of time than the second cure unit 18A. Further, adhesives applied by a screen print unit 24 (in preparation for the application of a label by a label unit 26) do not require curing.

In operation 124, the control system 22 can determine if additional decorating material 52 will be applied to the container exterior surface 9. As previously described, the decorator 10 may include any number of decorating units 20 that each apply different decorations and/or decorating materials 52 to the exterior surface 9. Each application of a decorating material can be registered with previously applied decorations or decorating materials. Accordingly, if additional decorating material will be applied by subsequent decorating units, the method 104 loops YES back to operation 110. Optionally, the decorator 10 includes one or more sensors 16 to sense the exterior surface 9 of metallic containers 8. The control system 22 can use the sensor data to determine the orientation of the decorations with respect to each subsequent decorating unit 20. If no additional decorations will be applied, method 104 proceeds NO to operation 126.

In operation 126, the metallic container 8 is removed from the mandrel 14. The decorated metallic container is then transported to downstream equipment 76 for subsequent operations. Method 104 then ends 128.

As discussed herein, specialty inks include, but are not limited to, a pigmented ink, a thermochromic ink, a photochromic ink, a scented thermochromic ink, a fluorescent ink, a UV ink, a glow-in-the-dark ink, a black light ink, an infrared ink, a phosphorescent ink, a pressure sensitive ink, a tactile ink, a tactile thermochromic ink, a leuco dye, a matte ink, and any other type of ink, dye, or varnish that changes appearance, color, and/or texture in response to temperature changes or exposure to light or pressure. Specialty inks and methods of using them are disclosed in U.S. Pat. No. 4,889,560, U.S. Pat. No. 5,502,476, U.S. Pat. No. 5,591,255, U.S. Pat. No. 5,919,839, U.S. Pat. No. 6,139,779, U.S. Pat. No. 6,174,937, U.S. Pat. No. 6,196,675, U.S. Pat. No. 6,309,453, U.S. Pat. No. 6,494,950, U.S. Pat. No. 7,810,922, U.S. Pat. No. 8,409,698, U.S. Patent Application Publication 2012/0238675, U.S. Patent Application Publication 2013/0075675, U.S. Patent Application Publication 2013/0105743, U.S. Patent Application Publication 2013/0231242, U.S. Patent Application Publication 2012/0315412, U.S. Patent Application Publication 2013/0340885, U.S. Patent Application Publication 2014/0039091, U.S. Patent Application Publication 2014/0072442, U.S. Patent Application Publication 2014/0187668, U.S. Patent Application Publication 2014/0210201, U.S. Patent Application Publication 2014/0212654, U.S. Patent Application Publication 2014/0272161, and International Publication No. WO 2014/096088 which are each incorporated herein in their entirety by reference.

The description of the present invention has been presented for purposes of illustration and description, but is not intended to be exhaustive or limiting of the invention to the form disclosed. Many modifications and variations will be apparent to those of ordinary skill in the art. The embodiments described and shown in the figures were chosen and described in order to best explain the principles of the invention, the practical application, and to enable those of ordinary skill in the art to understand the invention.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. It is to be expressly understood that such modifications and alterations are within the scope and spirit of the present invention, as set forth in the following claims.

What is claimed is:

1. An apparatus for applying a decorating material to a predetermined portion of a cylindrical exterior surface of a metallic container, comprising:
a conveyor to transport the metallic container;
a feeder to receive the metallic container from the conveyor;
a mandrel wheel in a predetermined alignment with respect to the feeder;
a plurality of mandrels interconnected to the mandrel wheel to receive metallic containers, each of the mandrels operable to rotate in at least one direction;
a sensor to sense an orientation of a first decoration on the cylindrical exterior surface of the metallic container on a mandrel, wherein if the first decoration is not in a predetermined orientation, the mandrel rotates to move the metallic container into the predetermined orientation; and
a first screen decorating unit aligned in a predetermined position with respect to the plurality of mandrels, the first screen decorating unit including a first cylindrical screen with a first mesh portion, a hollow interior, and a first varnish contained within the hollow interior, wherein the first mesh portion has a predetermined shape such that the first varnish is applied to the cylindrical exterior surface in a predetermined alignment with respect to the first decoration.

2. The apparatus of claim 1, wherein, if the first decoration is not in the predetermined orientation, the first cylindrical screen rotates to align the first mesh portion into the predetermined alignment with respect to the first decoration.

3. The apparatus of claim 1, wherein a sensor is associated with each of the plurality of mandrels.

4. The apparatus of claim 1, wherein the first cylindrical screen includes a second mesh portion spaced from the first mesh portion, wherein the second mesh portion has a second shape to apply the first varnish to another portion of the cylindrical exterior surface of the metallic container.

5. The apparatus of claim 1, wherein each mandrel has a mandrel axis which is substantially parallel to an axis of the mandrel wheel.

6. The apparatus of claim 5, wherein the first cylindrical screen of the first screen decorating unit is operable to rotate around a screen axis which is substantially parallel to the axis of the mandrel wheel.

7. The apparatus of claim 1, further comprising a cure element to cure the first varnish.

8. The apparatus of claim 7, wherein the cure element is interconnected to a hub of the mandrel wheel.

9. The apparatus of claim 1, further comprising a second screen decorating unit including a second cylindrical screen with a second mesh portion, a hollow interior, and a second decorating material contained within the hollow interior, wherein the second screen decorating unit can apply the second decorating material to a predetermined portion of the cylindrical exterior surface of the metallic container.

10. The apparatus of claim 9, further comprising a foil decorating unit to apply a foil label to a predetermined portion on the cylindrical exterior surface of the metallic container.

11. The apparatus of claim 9, wherein the second decorating material comprises a second varnish such that a first portion of the cylindrical exterior surface receives the first varnish and a second portion of the cylindrical exterior surface receives the second varnish.

12. The apparatus of claim 1, further comprising a control system that receives information from the sensor and determines an amount of rotation required for the mandrel to orient the metallic container in the predetermined orientation, wherein, if the first decoration is not in the predetermined orientation, the control system sends a signal to a drive unit of the mandrel which causes the mandrel to rotate in a specific direction.

13. A method of decorating an exterior surface of a cylindrical shaped metallic container in a screen printing process, comprising:
providing a cylindrical shaped metallic container;
positioning the cylindrical shaped metallic container on a mandrel of a decorator;
collecting information on the exterior surface of the cylindrical shaped metallic container;
determining, with the collected information, an alignment of the cylindrical shaped metallic container with respect to a cylinder of a screen decoration unit;
if the alignment of the metallic container is not in a predetermined orientation with respect to the cylinder, determining an amount of axial rotation required to properly align the cylindrical shaped metallic container and the cylinder;
activating a drive unit to rotate at least one of the cylinder of the screen decoration unit and the mandrel with the cylindrical shaped metallic container by the determined amount of axial rotation such that the cylindrical shaped metallic container and the cylinder are aligned in the predetermined orientation; and
conveying a decorating material through a mesh portion of the cylinder onto a predetermined portion of an exterior surface of the cylindrical shaped metallic container, wherein the decorating material comprises one of an ink, a varnish, and an adhesive.

14. The method of claim 13, wherein determining the alignment of the cylindrical shaped metallic container further comprises receiving, by a control system of the decorator, the information collected by the sensor, wherein the control system determines the alignment of the cylindrical shaped metallic container with respect to the cylinder.

15. The method of claim 13, further comprising:
moving the mandrel proximate to a second cylinder of a second screen decoration unit;
determining an alignment of the cylindrical shaped metallic container with respect to the second cylinder;
if the alignment of the metallic container is not in a predetermined orientation with respect to the second cylinder, determining an amount of axial rotation required to properly align the cylindrical shaped metallic container and the second cylinder;
activating a drive unit to rotate at least one of the second cylinder of the second screen decoration unit and the mandrel with the cylindrical shaped metallic container by the determined amount of axial rotation such that the cylindrical shaped metallic container and the second cylinder are aligned in the predetermined orientation; and
conveying a second decorating material through a second mesh portion of the second cylinder onto the exterior surface of the cylindrical shaped metallic container, wherein the decorating material is a first varnish and the second decorating material is a different second varnish.

16. The method of claim 13, wherein the cylindrical shaped metallic container includes a first decoration applied to the exterior surface before the cylindrical shaped metallic container is arranged on the mandrel of the decorator, and wherein by rotating the mandrel by the determined amount the decorating material conveyed by the screen decoration unit is registered with the first decoration.

17. The method of claim 13, wherein the decorating material is a varnish which is conveyed to a select portion of the exterior surface such that the select portion includes the varnish isolated from another portion of the exterior surface which does not include a varnish.

18. A non-transitory computer readable medium stored on a storage medium and having instructions that when executed by a processor of a control system cause the processor to perform a method of orienting and registering a decoration on an exterior surface of a metallic container with a screen print unit of a decorator, comprising:
instructions to receive information from a sensor related to an orientation of a metallic container positioned on a mandrel of the decorator;
instructions to determine an alignment of the decoration on the metallic container with respect to the screen print unit of the decorator;
instructions to determine an amount of rotation required to align the metallic container and a cylindrical screen of the screen print unit in a predetermined orientation; and
instructions to send a signal to a drive unit of at least one of the cylindrical screen and the mandrel, wherein, in response to receiving the signal, the drive unit rotates at least one of the cylindrical screen and the mandrel in a specific direction such that a decorating material can be transferred from a hollow interior portion of the cylindrical screen to a predetermined select portion of the exterior surface of the metallic container.

19. The non-transitory computer readable medium of claim 18, wherein the decorating material is one of an ink, a varnish, and an adhesive.

20. The non-transitory computer readable medium of claim 18, wherein the cylindrical screen includes a mesh portion of a predetermine size and shape such that the decorating material is not transferred to the decoration on the metallic container.
